(19) United States
(12) Patent Application Publication
(10) Pub. No.: US 2026/0111949 A1
(43) Pub. Date: Apr. 23, 2026

(54) 3D MODEL UTILIZATION APPARATUS, CONTROL METHOD OF 3D MODEL UTILIZATION APPARATUS, AND NON-TRANSITORY COMPUTER-READABLE STORAGE MEDIUM

(71) Applicant: NEC Corporation, Tokyo (JP)

(72) Inventors: Yasuhiko YOSHIDA, Tokyo (JP); Kazuma KUNIYOSHI, Tokyo (JP); Eiji KANEKO, Tokyo (JP); Yoshitomo WARASHINA, Tokyo (JP)

(73) Assignee: NEC Corporation, Tokyo (JP)

(21) Appl. No.: 19/347,948

(22) Filed: Oct. 2, 2025

(30) Foreign Application Priority Data
Oct. 21, 2024 (JP) 2024-184642

(51) Int. Cl. G06Q 30/0601; G06T 17/00

(52) U.S. Cl. CPC G06Q 30/06433; G06T 17/00

(57) ABSTRACT

A 3D model utilization apparatus includes an acquisition means, a generation means, and a utilization means. The acquisition means acquires appearance information and genre information related to digital content corresponding to a product purchased by a user. The generation means generates a 3D model corresponding to the digital content based on the acquired appearance information and genre information. The utilization means uses the generated 3D model in a metaverse space.

### INCORPORATION BY REFERENCE

This application is based upon and claims the benefit of priority from Japanese Patent Application No. 2024-184642, filed on October 21, 2024, the disclosure of which is incorporated herein in its entirety by reference.

### TECHNICAL FIELD

The present disclosure relates to a 3D model utilization apparatus, a control method of a 3D model utilization apparatus, and a non-transitory computer-readable storage medium.

### BACKGROUND ART

There exists a technique for associating an image with a predetermined item that is available for use in a virtual space.

For example, Patent Literature 1 (JP2024-077564 A) describes that a suitable image or the like is associated with a predetermined item that is available for use in a virtual space.

The information processing system of Patent Literature 1 includes a user input acquisition unit, an image acquisition unit, and an association processing unit.

The user input acquisition unit acquires a predetermined input from a user. The image acquisition unit utilizes a first machine learning model constructed using artificial intelligence and acquires a specific image that is obtained by inputting the predetermined input into the first machine learning model. The association processing unit associates the specific image with the predetermined item that is available for use in the virtual space.

There are users who wish to use an object corresponding to a purchased item such as a book, CD, or DVD in a virtual space such as a metaverse. However, a server or the like that realizes the virtual space is not able to know the appearance or type of the product purchased by the user. As a result, the server or the like is not able to appropriately utilize the object corresponding to the book or the like.

It should be noted that Patent Literature 1 merely discloses a technique for associating an image with an item available for use in a virtual space. Therefore, even in a case where the technique disclosed in Patent Literature 1 is applied, it is not possible to solve the above-described problem.

### SUMMARY

It is a main object of the present disclosure to provide a 3D model utilization apparatus, a control method of a 3D model utilization apparatus, and a non-transitory computer-readable storage medium that contribute to enabling appropriate use, in a virtual space, of an object corresponding to a product such as a book or a CD.

According to a first aspect of the present disclosure, there is provided a 3D model utilization apparatus including: an acquisition means that acquires appearance information and genre information related to digital content corresponding to a product purchased by a user; a generation means that generates a 3D model corresponding to the digital content based on the acquired appearance information and genre information; and a utilization means that uses the generated 3D model in a metaverse space.

According to a second aspect of the present disclosure, there is provided a control method of a 3D model utilization apparatus, the control method including: acquiring appearance information and genre information related to digital content corresponding to a product purchased by a user; generating a 3D model corresponding to the digital content based on the acquired appearance information and genre information; and using the generated 3D model in a metaverse space.

According to a third aspect of the present disclosure, there is provided a non-transitory computer-readable storage medium storing a program causing a computer mounted on a 3D model utilization apparatus to perform processing for: acquiring appearance information and genre information related to digital content corresponding to a product purchased by a user; generating a 3D model corresponding to the digital content based on the acquired appearance information and genre information; and using the generated 3D model in a metaverse space.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an outline of an example embodiment;

FIG. 2 is a flowchart illustrating an operation of an example embodiment;

FIG. 3 is a diagram illustrating an example of a schematic configuration of an information processing system according to an embodiment of the present disclosure;

FIG. 4 is a diagram for explaining an operation of the information processing system according to the embodiment of the present disclosure;

FIG. 5 is a diagram for explaining an operation of the information processing system according to the embodiment of the present disclosure;

FIG. 6 is a diagram for explaining an operation of the information processing system according to the embodiment of the present disclosure;

FIG. 7 is a diagram illustrating an example of a processing configuration of an integrated management server according to the embodiment of the present disclosure;

FIG. 8 is a diagram illustrating an example of a user management database according to the embodiment of the present disclosure;

FIG. 9 is a diagram illustrating an example of a display of a terminal according to the embodiment of the present disclosure;

FIG. 10 is a diagram illustrating an example of a display of the terminal according to the embodiment of the present disclosure;

FIG. 11 is a diagram illustrating an example of a processing configuration of an NFT management server according to the embodiment of the present disclosure;

FIG. 12 is a flowchart illustrating an example of an operation of a sales control unit according to the embodiment of the present disclosure;

FIG. 13 is a diagram illustrating an example of a display of a terminal according to the embodiment of the present disclosure;

FIG. 14 is a diagram illustrating an example of a processing configuration of a metaverse server according to the embodiment of the present disclosure;

FIG. 15 is a diagram illustrating an example of a display of the terminal according to the embodiment of the present disclosure;

FIG. 16 is a diagram illustrating an example of a display of the terminal according to the embodiment of the present disclosure;

FIG. 17 is a diagram illustrating an example of a display of the terminal according to the embodiment of the present disclosure;

FIG. 18 is a diagram illustrating an example of a display of the terminal according to the embodiment of the present disclosure;

FIG. 19 is a diagram illustrating an example of a display of the terminal according to the embodiment of the present disclosure;

FIG. 20 is a diagram illustrating an example of a display of the terminal according to the embodiment of the present disclosure;

FIG. 21 is a diagram illustrating an example of a display of the terminal according to the embodiment of the present disclosure;

FIG. 22 is a diagram illustrating an example of a display of the terminal according to the embodiment of the present disclosure;

FIG. 23 is a sequence diagram illustrating an example of an operation of the information processing system according to the embodiment of the present disclosure; and

FIG. 24 is a diagram illustrating an example of a hardware configuration of the NFT management server according to the present disclosure.

### EXAMPLE EMBODIMENT

First, an outline of an example embodiment will be described. It should be noted that in the following outline, various components are denoted by reference characters for the sake of convenience. That is, the following reference characters are used as examples to facilitate the understanding of the present disclosure. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. It should be noted that in the present description and drawings, elements that can be described in a like way will be denoted by a like reference character, and redundant description thereof will be omitted as needed.

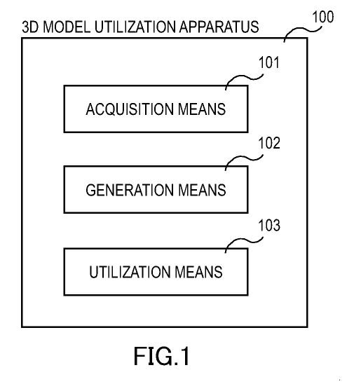

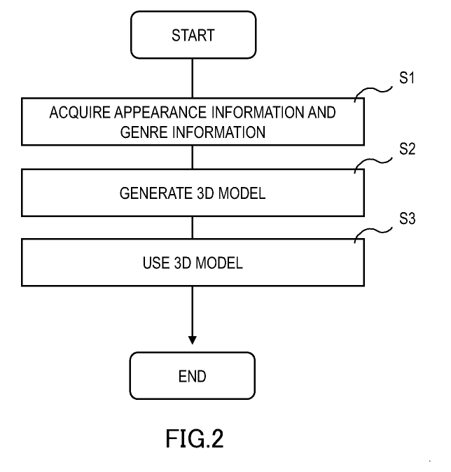

A 3D model utilization apparatus 100 according to an example embodiment includes an acquisition means 101, a generation means 102, and a utilization means 103 (see FIG. 1). The acquisition means 101 acquires appearance information and genre information related to digital content corresponding to a product purchased by a user (step S1 in FIG. 2). The generation means 102 generates a 3D model corresponding to the digital content based on the acquired appearance information and genre information (step S2). The utilization means 103 uses the generated 3D model in a metaverse space (step S3).

The 3D model utilization apparatus 100 acquires information related to an appearance of the product and information related to a genre of the product in a case where an object corresponding to a product such as a book or CD purchased by the user is used in the metaverse space. For example, the 3D model utilization apparatus 100 acquires the appearance information and the genre information from a server or the like that manages intellectual property rights related to the product such as the book. The 3D model utilization apparatus 100 generates a 3D model (a 3D model for display in the metaverse space) corresponding to the book or the like purchased by the user using the acquired appearance information and genre information. The 3D model utilization apparatus 100 uses the generated 3D model in the metaverse space. At that time, the above appearance information and genre information are set to an appropriate appearance and genre determined by a right holder of the book or the like, so that an object corresponding to the book or the like is not used with an appearance unintended by the right holder. As a result, objects corresponding to products such as books and CDs are appropriately used in the virtual space.

Hereinafter, specific example embodiments will be described in more detail with reference to drawings.

### [First Example Embodiment]

A first example embodiment will be described in more detail with reference to drawings.

An information processing system according to the first example embodiment issues a Non-Fungible Token (NFT) for digital content corresponding to a product purchased by a user. For example, in a case where a user purchases a figure, an NFT targeting 3D data (3D model) of the figure is issued. Alternatively, in a case where a user purchases a character in a game, an NFT targeting a three-dimensional (3D) model of the character is issued.

### [System Configuration]

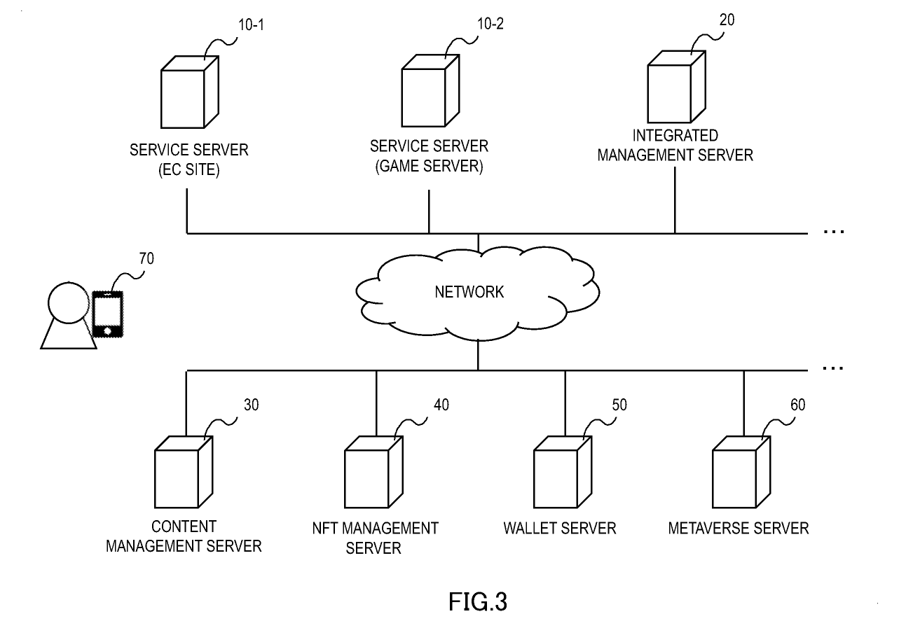

As shown in FIG. 3, the information processing system according to the first example embodiment includes a plurality of service servers 10-1 and 10-2, an integrated management server 20, a content management server 30, an NFT management server 40, a wallet server 50, and a metaverse server 60.

In the following description, in a case where there is no particular reason to distinguish between the service servers 10-1 and 10-2, they will simply be referred to as "service server 10."

A user possesses a terminal 70 such as a smartphone or an HMD (Head Mounted Display). The user operates the terminal 70 to access various servers or the like.

The service server 10 is a server that is managed and operated by a service business operator providing various services to users.

The service server 10-1 provides an EC (Electronic Commerce) site that sells products (tangible items) such as figures(digital figures in games or virtual spaces), CDs, and DVDs, for example. Alternatively, the service server 10-1 may sell books or electronic books.

The service server 10-2 provides an online game, for example. The service server 10-2 (game server) not only controls the progress of the game but also sells to users characters (characters appearing in the game) or the like that are used in the game. The user is able to progress through the game using a character that has been purchased. That is, the service server 10-2 sells to the user the right to use a character or the like during the game.

It should be noted that, in the first example embodiment, a case in which the service server 10-2 provides a 3D game is taken as an example to describe the configuration and operation of the information processing system. However, it is not intended to limit the games targeted by the information processing system to 3D games. The games disclosed in the present application include an FPS (First Person Shooter), an action game, a fighting game, an RPG (Role Playing Game), or the like.

The integrated management server 20 is a server that is managed and operated by a business operator (platform business operator) that provides a management platform for purchased products across a plurality of service business operators (service servers 10). The integrated management server 20 provides a cross-service management service (management service related to purchased products or the like) for at least one or more service servers 10 in which the user has an account.

It should be noted that the products in the present application disclosed include not only tangible items such as figures, CDs, and DVDs, but also intangible items such as characters used in a game. That is, the products in the present application disclosed include not only tangible items in a physical space but also characters, items, or the like that exist in a 3D space. In the above example, a right to use a character or the like that appears in a game and is sold by a game server is also included as a product. In addition, a service provided by a service business operator to a user is also included as a product. Furthermore, the products in the present application disclosed are not limited to items transferred for a fee and also include items transferred without charge.

The integrated management server 20 is linked with each service server 10 through account integration. Specifically, the user is able to log into an account created for each service business operator (service server 10) via the integrated management server 20. The user purchases a product or plays a game on the service server 10 into which the user has logged in.

The integrated management server 20 is capable of acquiring a behavior history of the user on the service server 10. More specifically, the integrated management server 20 is capable of acquiring a purchase history of products, a play history of games, or the like. The integrated management server 20 generates a purchase product list of the user based on a purchase history of products purchased at an EC site, a play history of games played on a game server, or the like.

The content management server 30 is a server that performs control and management related to digital content corresponding to figures, CDs, DVDs, or the like sold to general consumers, and digital content corresponding to characters or the like sold to game users.

For example, a server that is managed and operated by an IP (Intellectual Property) holder such as a record company, a figure manufacturer, or a game manufacturer, and that performs control and management related to its own IP (intellectual property rights), corresponds to the content management server 30.

The NFT management server 40 is a server that is managed and operated by a business operator that issues NFTs (Non-Fungible Tokens) or the like. The NFT management server 40 issues (generates) an NFT for digital content corresponding to a product purchased by a user from a service business operator (an operator that operates an EC site or an online game). The NFT management server 40 includes a function as an NFT generation apparatus that generates an NFT.

In addition, the NFT management server 40 realizes a so-called marketplace. The NFT management server 40 enables buying and selling of NFT-converted digital content (digital assets) through the marketplace.

The wallet server 50 is a server that provides a wallet service related to tokens such as NFTs and SBTs (SoulBound Tokens). A user is able to prove ownership of an NFT or an SBT by opening an account (wallet) on the wallet server 50.

The metaverse server 60 is a server that provides a virtual space to users. The metaverse server 60 is a virtual space control apparatus that performs control related to a virtual space. A user accesses the metaverse server 60 using an HMD or the like and performs activities in the metaverse space provided by the metaverse server 60. The metaverse server 60 includes both a function as an NFT utilization apparatus that utilizes NFT-converted digital content and a function as a 3D model utilization apparatus.

Each apparatus shown in FIG. 3 is connected to a network. Specifically, the service server 10, the integrated management server 20, the content management server 30, the NFT management server 40, the wallet server 50, the metaverse server 60, and the terminal 70 are connected to a network via wired or wireless communication means.

The configuration of the information processing system shown in FIG. 3 is illustrative and is not intended to limit the configuration. For example, a plurality of integrated management servers 20 may be included in the system. Load distribution and redundancy may be realized by the plurality of integrated management servers 20.

### [Schematic Operation]

Subsequently, a schematic operation of the information processing system according to the first example embodiment will be described.

### Account Generation

A user generates an account with each service business operator in order to purchase a figure or the like, play an online game, use the integrated management service, use the marketplace, and enjoy the wallet service.

Specifically, the user operates the terminal 70 to access the wallet server 50 and generates an account (wallet). The user operates the terminal 70 to generate an account on an EC site that handles a product the user wishes to purchase or on a game server for a game the user wishes to play. The user operates the terminal 70 to generate an account on the integrated management server 20. The user operates the terminal 70 to generate an account (an account of the marketplace) on the NFT management server 40.

### Account Integration

The user sets login information for logging into each service server 10 in the integrated management server 20. For example, the user sets login information (ID and password) for logging into an EC site, and login information for logging into a game server, in the integrated management server 20.

In addition, the user sets a wallet address (a wallet address generated by the wallet server 50) in each of the service server 10, the integrated management server 20, the NFT management server 40, and the metaverse server 60.

Each server stores the wallet address in association with the login information (ID and password) or the like of the user.

### Product Purchase

Here, a case in which a user logs into an EC site (service server 10-1) and purchases a figure is taken as an example to describe the operation or the like of the information processing system.

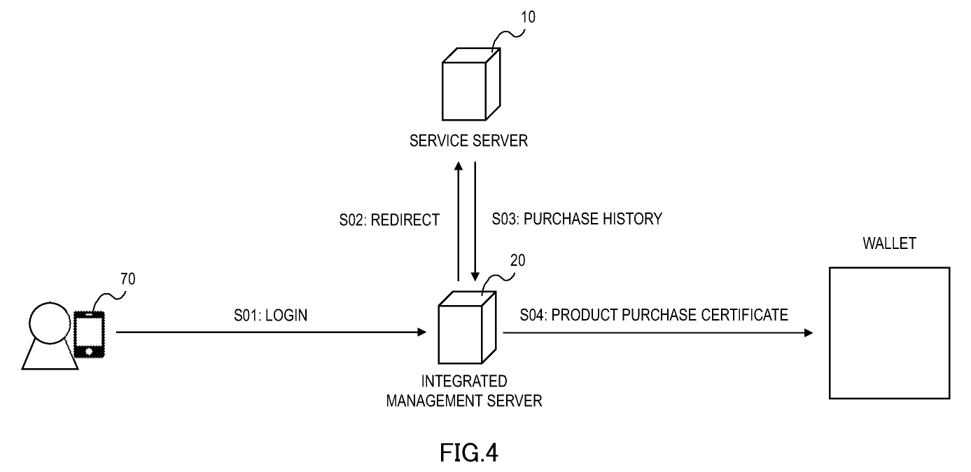

To purchase the figure, the user logs into an account of the integrated management server 20 (step S01 in FIG. 4). The integrated management server 20 displays a list of EC sites on the terminal 70, thereby allowing the user to select an EC site.

The integrated management server 20 redirects the connection destination of the terminal 70 to a login page of the EC site selected by the user (step S02). Specifically, the integrated management server 20 transmits to the terminal 70 a URL (Uniform Resource Locator) for logging into an account of the EC site selected by the user.

The URL transmitted to the terminal 70 is a URL for redirection for connecting the terminal 70 to a login page of the EC site, and the URL for redirection includes login information (ID and password) of the user embedded therein.

Upon receiving the URL for redirection, the terminal 70 accesses the login page of the EC site in accordance with the URL. At that time, since the URL for redirection includes login information, the EC site (the service server 10) acquires login information of the user and performs authentication.

The user purchases a figure on the EC site into which the user has logged in.

The EC site stores a purchase history of a product (the figure) purchased by the user. Specifically, the EC site (the service server 10-1) stores, as a purchase history, information such as a product name, product code, price, purchase date, and manufacturer name of the sold product.

It should be noted that a person in charge of the EC site or the like acquires information such as a product name and a product code from a manufacturer or the like of the product, and registers the acquired information in the service server 10.

The integrated management server 20 acquires a purchase history related to a product purchased by the user on the EC site. For example, the integrated management server 20 accesses an EC site on which the user has previously logged in, at regular intervals or at a predetermined timing, and acquires a purchase history of a product purchased by the user on the EC site.

For example, the integrated management server 20 acquires a purchase history including information of a purchased product (for example, a product name, a product code, a price, a purchase date, a manufacturer name, or the like) (step S03). The integrated management server 20 stores the purchase history of the user in an account of the user.

It should be noted that the integrated management server 20 acquires a play history of the game by the user with respect to a product sold in an online game, and extracts a purchase history of a product or the like purchased by the user from the play history. The integrated management server 20 stores the extracted purchase history (purchase history of a character) in an account of the user.

### Purchase of NFT Content of Purchased Product

A user who has purchased a product is able to purchase digital content corresponding to the purchased product. For example, in a case where a user has purchased a figure, the user is able to purchase a 3D model (3D data) of the figure. Alternatively, in a case where a user has purchased a character used in a game, the user is able to purchase a 3D model of the character.

It should be noted that a 3D model refers to a three-dimensionally depicted graphic used in a 3D game or a metaverse space and is three-dimensional shape data. The 3D model is 3D shape information such as a polygon model composed of a combination of faces, edges, and vertices, or a sculpt model composed of a large number of polygons. The 3D model is data having a variable shape, in which positional relationships or angles of an object can be changed, or a texture of a surface of the object can be changed while maintaining the shape.

Alternatively, in a case where a user has purchased a CD or a DVD, the user is able to purchase sound source data of each song stored in the CD or video data such as a movie stored in the DVD. Alternatively, in a case where a user has purchased a book or an electronic book, the user is able to purchase book data in which contents of the book have been digitized.

Digital content corresponding to a product purchased by a user is converted into an NFT. It should be noted that, in the following description, NFT-converted digital content corresponding to a product purchased by a user is referred to as "NFT content."

A user who desires to purchase NFT content logs in to the integrated management server 20. The user makes a request to the integrated management server 20 (platform business operator) for issuance of a purchase certificate of a product corresponding to the NFT content the user desires to purchase. Specifically, in a case where a user performs a predetermined operation (for example, pressing a purchase certificate issuance button), the integrated management server 20 displays, on the terminal 70, a list of products already purchased by the user. The user selects, from among the displayed list of products, a product for which the user desires to purchase NFT content.

In a case where the user selects a product, the integrated management server 20 issues a purchase certificate of the product selected by the user. Specifically, the integrated management server 20 issues a purchase certificate of the product, the certificate including information for identifying a purchaser of the product and information related to the product, and setting a platform business operator as an issuer.

For example, the integrated management server 20 issues a purchase certificate of the product in which a wallet address is set as the information for identifying a purchaser of the product and in which product-related information includes a product name, a product code, a price, a purchase date, a name of a manufacturer, or the like.

In the first example embodiment, a case will be described in which the integrated management server 20 issues a purchase certificate of the product as an SBT (SoulBound Token).

First, a person in charge of the platform business operator or the like generates a smart contract for issuing the purchase certificate of the product including the above-described content, and deploys the generated smart contract to a blockchain.

In a case where the purchase certificate of the product is required to be issued, the integrated management server 20 calls a function of the smart contract and inputs information necessary for issuing the purchase certificate of the product (such as a wallet address, product-related information, and an ID of the platform business operator).

By executing the smart contract, the wallet of the user (wallet address) is associated with the SBT issued as the purchase certificate of the product.

As described above, the integrated management server 20 issues, as the purchase certificate of the product, an SBT in which the platform business operator is an issuer and the purchaser of the product is an owner (step S04).

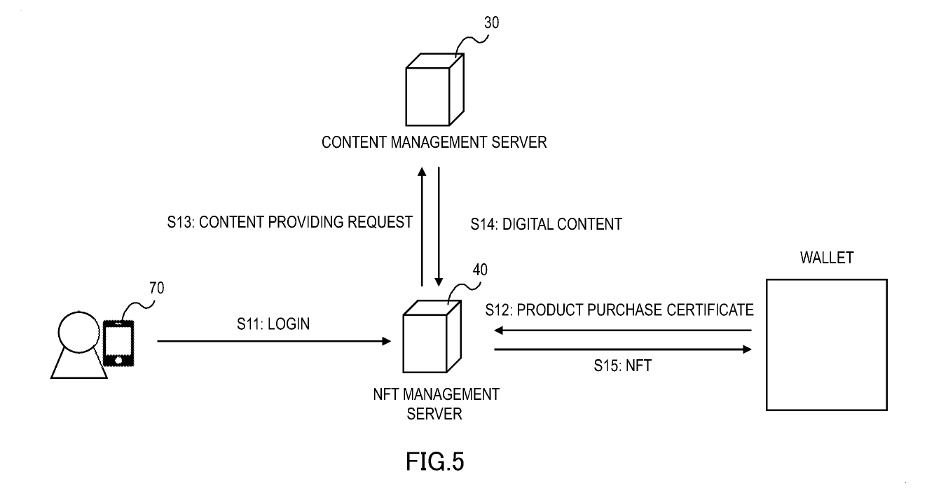

By receiving the issuance of the purchase certificate of the product, the user is able to purchase NFT content. In this case, the user logs into a marketplace provided by the NFT management server 40 (step S11 in FIG. 5).

In a case where the user performs a predetermined operation (for example, presses an NFT content purchase button), the NFT management server 40 acquires the purchase certificate of the product from the wallet of the user by using the wallet address of the user (step S12). The NFT management server 40 displays, on the terminal 70, a list of products corresponding to the purchase certificates of the products owned by the user.

The user selects a product, from the displayed list of products, for which the purchase of NFT content is desired.

In a case where the user selects a product, the NFT management server 40 verifies the purchase certificate of the product corresponding to the product selected by the user. For example, the NFT management server 40 determines whether or not the issuer of the purchase certificate of the product is a predetermined issuer (that is, determines whether or not the issuer is a reliable platform business operator).

In a case where the verification of the purchase certificate of the product is successful, the NFT management server 40 acquires the digital content to be sold (digital content to be converted into an NFT) and accompanying information related thereto from the content management server 30. Specifically, the NFT management server 40 acquires the digital content and the accompanying information from the content management server 30 of the IP holder of the product corresponding to the NFT content.

For example, in a case where the user desires to purchase NFT content corresponding to a figure purchased by the user, the NFT management server 40 acquires digital content (a 3D model) related to the figure from the content management server 30 managed by the manufacturer of the figure.

Alternatively, in a case where the user desires to purchase NFT content corresponding to a CD purchased by the user, the NFT management server 40 acquires digital content (audio data) of the CD from the content management server 30 managed by the record company.

Alternatively, in a case where the user desires to purchase NFT content corresponding to a character used in a game, the NFT management server 40 acquires digital content (a 3D model) of the character from the content management server 30 managed by the game manufacturer.

Specifically, the NFT management server 40 transmits information for specifying a product corresponding to the NFT content that the user desires to purchase to the content management server 30. For example, the NFT management server 40 transmits a "content providing request" including a product code of a figure, a CD, a character, or the like to the content management server 30 (step S13).

The content management server 30 that has received the content providing request transmits digital content corresponding to the product code included in the request and accompanying information related thereto to the NFT management server 40 (step S14). For example, the content management server 30 transmits a response including a 3D model of a figure, a character, or the like and accompanying information related thereto to the NFT management server 40.

As the accompanying information related to the digital content, examples include information referred to at the time of use of the digital content (for example, a 3D model or audio data), information related to the usage restrictions of the digital content, or the like. A more detailed explanation related to the accompanying information of the digital content will be described below.

It should be noted that a manufacturer of figures, a record company, a game manufacturer, or the like registers, in advance, a product code for a product handled by the company, digital content (for example, a 3D model of a character, audio data of a CD), accompanying information related thereto, or the like in the content management server 30. The manufacturer or the like registers the digital content and the accompanying information in the content management server 30 in accordance with its own policies or the like.

Before or after the acquisition of the digital content, in a case where payment for the NFT content has been completed, the NFT management server 40 issues an NFT whose owner is the purchaser of the NFT content (step S15). Specifically, the NFT management server 40 issues (generates) an NFT by using a smart contract, wherein the purchaser of the product is set as the owner and the NFT issuing business operator is set as the issuer.

More specifically, the NFT management server 40 issues an NFT including, in metadata, information related to the product serving as the basis of the NFT content (for example, a product name, a product code, a price), a description of the NFT content (a type of the NFT content; for example, a 3D model), or the like.

In a case where the NFT of the NFT content is issued, the user's wallet (wallet address) is associated with the NFT of the NFT content. It should be noted that the NFT content (digital content) and the accompanying information related thereto are stored in storage of the NFT management server 40. A link (URL) for accessing a storage destination of the NFT content or the like is described in the NFT.

A user logs in to a marketplace and is able to check the NFT content (digital content) stored in the NFT management server 40.

### Use of NFT Content in Metaverse Space

A user who has purchased NFT content is able to use the NFT content in a metaverse space.

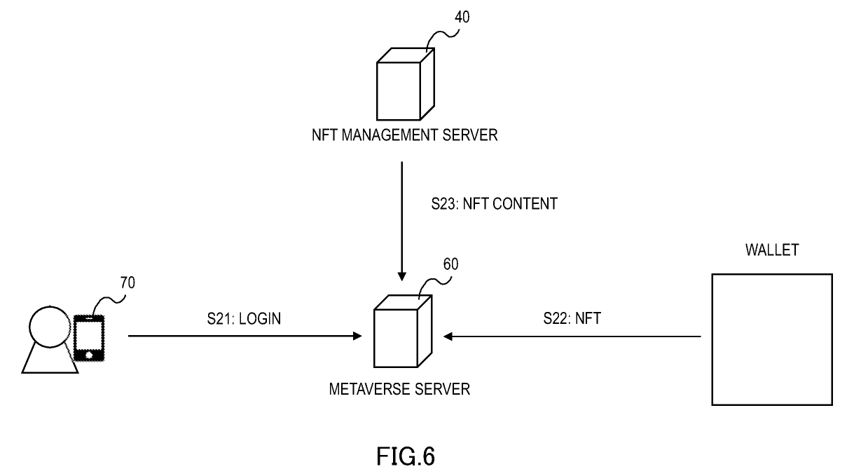

A user who intends to use the NFT content in the metaverse space logs in to the metaverse server 60 (step S21 in FIG. 6). The user instructs the logged-in metaverse server 60 to acquire the NFT content. In response to the instruction, the metaverse server 60 accesses the wallet of the user and acquires the NFT corresponding to the NFT content owned by the user (step S22).

In a case where the NFT has been acquired, the metaverse server 60 displays, on the terminal 70, a list of information related to the NFT content corresponding to the acquired NFT, thereby allowing the user to select NFT content (NFT content desired to be used in the metaverse). For example, the metaverse server 60 displays, on the terminal 70, a list of product names corresponding to the NFT content (for example, a figure name, a CD title, a character name).

Subsequently, the metaverse server 60 accesses the NFT management server 40 and acquires the NFT content and the like corresponding to the NFT selected by the user (step S23). The user can use the acquired NFT content in the metaverse space.

For example, the metaverse server 60 acquires from the user the usage mode of the acquired NFT content. As one example, in a case where the user owns NFT content of a figure, the user is able to display the figure in the user's own room on the metaverse. As another example, in a case where the user owns NFT content of a CD, the user is able to reproduce in the user's own room the audio data corresponding to the CD. As yet another example, in a case where the user owns NFT content corresponding to a game character, the user is able to place the character in the user's own virtual room in the metaverse space.

At that time, the metaverse server 60 uses accompanying information obtained together with the NFT content to utilize the NFT content (for example, a 3D model of a character used in a game) in the metaverse space. For example, the metaverse server 60 models the character in the metaverse space with a height specified by the game manufacturer. Alternatively, the metaverse server 60 models in the metaverse space a CD jacket obtained from the accompanying information. Alternatively, in a case where the usage mode of the NFT content is specified by a rights holder or the like as accompanying information, the user is allowed to use the NFT content only in the specified usage mode. For example, in a case where the usage mode of a 3D model of a character is specified as "for display in space only," the user is not allowed to use the 3D model as an avatar. For example, in a case where the usage mode of a 3D model of a weapon is specified as "for use only as an accessory," the user is not allowed to place the 3D model in the space.

Next, details of the individual apparatuses included in the information processing system according to the first example embodiment will be described.

### [Integrated Management Server]

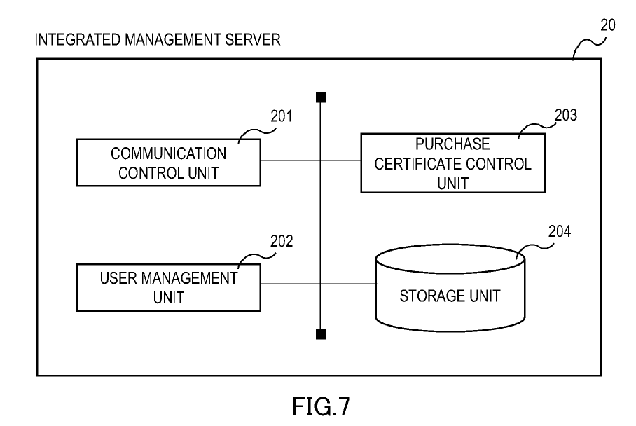

FIG. 7 is a diagram showing an example of a processing configuration (processing modules) of the integrated management server 20 according to the embodiment of the present disclosure. Referring to FIG. 7, the integrated management server 20 includes a communication control unit 201, a user management unit 202, a purchase certificate control unit 203, and a storage unit 204.

The communication control unit 201 is means for controlling communication with other apparatuses. For example, the communication control unit 201 receives data (packets) from the terminal 70. In addition, the communication control unit 201 transmits data to the terminal 70. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The user management unit 202 is means for performing control and management relating to users.

The user management unit 202 acquires information such as a name, gender, date of birth, and login information (ID, password) from a user who has accessed a predetermined website (for example, a user registration site). Furthermore, the user management unit 202 acquires the user's wallet address and login information for logging into each service server 10 for which the user has created an account.

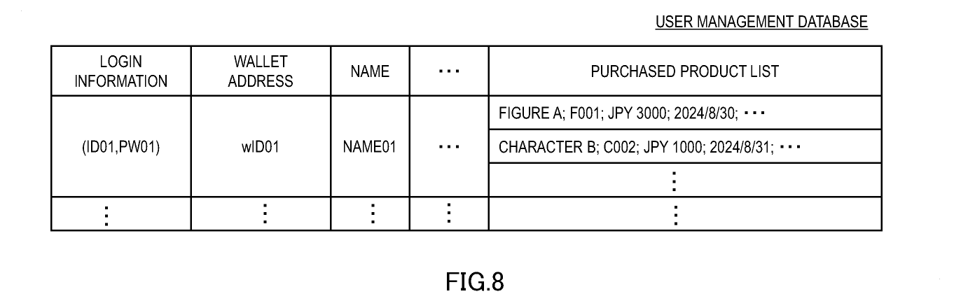

The user management unit 202 stores the acquired name, wallet address, and login information for logging into the service server 10 in a user management database (see FIG. 8). The user management unit 202 associates and stores, in each user's account, the information of the service server 10 (EC site, game server) with the login information. It should be noted that the user management database shown in FIG. 8 is an example, and is not intended to limit the items stored therein. For example, the user management database may store biometric information of the user (for example, a face image).

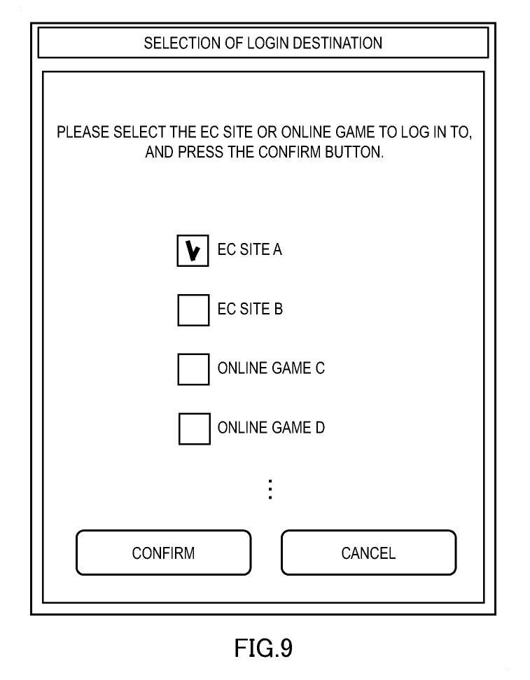

The user management unit 202, in a case where a logged-in user desires to purchase a product or play a game, displays on the terminal 70 possessed by the user a list of EC sites and game servers into which the user is able to log in. For example, the user management unit 202 displays, on the terminal 70, a GUI (Graphical User Interface) as shown in FIG. 9, and enables the user to select an EC site or an online game.

Upon the user selecting an EC site or an online game to log into, the user management unit 202 redirects the connection destination of the terminal 70 to the login page of the EC site or the like selected by the user. In this case, the user management unit 202 transmits to the terminal 70 a URL for redirection into which the login information of the logged-in user's account (login information corresponding to the EC site or the like to be logged into) is embedded.

The purchase certificate control unit 203 is means for performing control relating to purchase certificates for products purchased by the user. Specifically, the purchase certificate control unit 203 issues, to the user who has purchased a product (for example, a figure, a CD, or a game character), a purchase certificate for the product as an SBT. More specifically, the purchase certificate control unit 203 issues, to the user, an SBT proving that the user has purchased the product, using the wallet address of the user.

The purchase certificate control unit 203 accesses, at regular intervals or at predetermined timings, each EC site or game server (service server 10) for which login information is registered in the user's account. The purchase certificate control unit 203 logs into the EC site or the like using the login information corresponding to each EC site or game server.

The purchase certificate control unit 203 acquires, from the purchase history page of the logged-in service server 10, the purchase history of products purchased by the user. Alternatively, the purchase certificate control unit 203 acquires, from the play history page of the logged-in service server 10, the play history of games played by the user.

Alternatively, the purchase certificate control unit 203 may, while logged into the service server 10, acquire the user's purchase history or play history by using an API (Application Programming Interface) or the like predetermined by the service provider.

Upon acquiring the purchase history of products, the purchase certificate control unit 203 stores, in the purchased product list field of the user management database, information on the products purchased by the user (for example, product name, product code, price, purchase date, manufacturer name, and so on) as well as information on the EC site or the like from which the product was purchased.

Alternatively, upon acquiring a gameplay history of a game, the purchase certificate control unit 203 extracts a purchase history of items (for example, characters, weapons, accessories, items, and skins such as armor, clothing, and innerwear) from the gameplay history, and stores the information of the corresponding items in the user management database.

It should be noted that, in a case where the acquired purchase history is already stored in the user management database, the purchase certificate control unit 203 may either discard the acquired product purchase history or overwrite the corresponding purchase history.

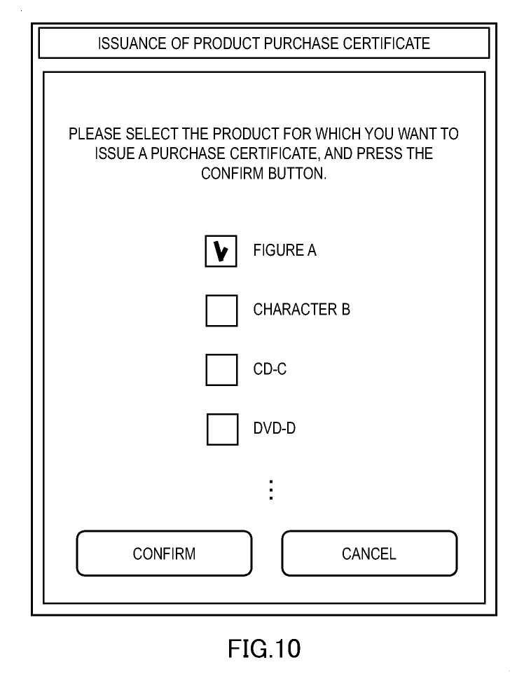

In the case where a user who has logged into the account wishes to have a product purchase certificate issued, the purchase certificate control unit 203 displays a list of products purchased by the user (products listed in the purchased product list) and specifies the product for which the user wishes to have the purchase certificate issued. For example, the purchase certificate control unit 203 displays a GUI as illustrated in FIG. 10 to identify the product for which the user desires issuance of the product purchase certificate.

Once the user specifies the product for which the user wishes to have a product purchase certificate issued, the purchase certificate control unit 203 calls a function of a smart contract deployed on a node on the blockchain and issues an SBT of the product purchase certificate.

For example, the purchase certificate control unit 203 inputs, into the smart contract, the wallet address as the address of the recipient of the SBT and the wallet address of the platform operator as the ID of the issuer of the SBT. Furthermore, the purchase certificate control unit 203 may also input into the smart contract, as information relating to the product purchased by the user, information such as the product name, product code, price, purchase date, and name of the manufacturer of the product.

The smart contract uses this information to issue, as a product purchase certificate, an SBT in which the purchaser of the product is set as the owner and the platform operator is set as the issuer, and which includes information relating to the purchased product in metadata.

It should be noted that the issuance of an SBT using a smart contract is not the purpose of the present disclosure, and thus a more detailed description thereof will be omitted.

The storage unit 204 is means for storing information necessary for the operation of the integrated management server 20. For example, the storage unit 204 stores, in association, the names of EC sites and online games with the URLs of their login pages.

### [NFT Management Server]

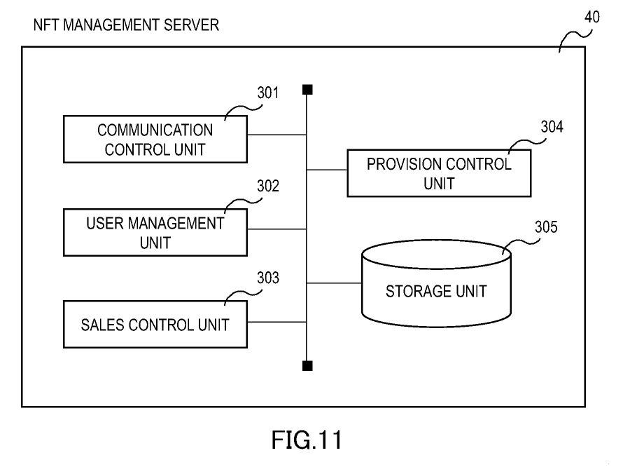

FIG. 11 is a diagram showing an example of a processing configuration (processing modules) of the NFT management server 40 according to the embodiment of the present disclosure. Referring to FIG. 11, the NFT management server 40 includes a communication control unit 301, a user management unit 302, a sales control unit 303, a provision control unit 304, and a storage unit 305.

The communication control unit 301 is means for controlling communication with other apparatuses. For example, the communication control unit 301 receives data (packets) from the terminal 70. In addition, the communication control unit 301 transmits data to the terminal 70. The communication control unit 301 gives data received from other apparatuses to other processing modules. The communication control unit 301 transmits data acquired from other processing modules to other apparatuses. In this way, other processing modules transmit and receive data to and from other apparatuses via the communication control unit 301. The communication control unit 301 includes a function as a receiving unit that receives data from other apparatuses and a function as a transmitting unit that transmits data to other apparatuses.

The user management unit 302 is means for performing control and management relating to users.

The user management unit 302 acquires information such as name, gender, date of birth, and login information (ID, password) from a user who has accessed a predetermined website (for example, a user registration site). Furthermore, the user management unit 302 acquires a wallet address. The user management unit 302 stores the acquired name, login information, wallet address, and the like in a predetermined database.

The sales control unit 303 is means for executing control relating to the sale of NFT content.

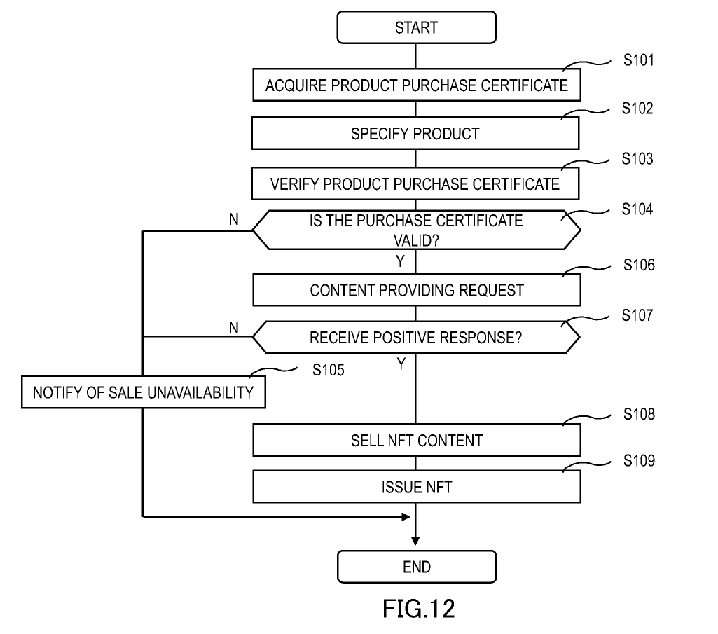

FIG. 12 is a flowchart showing one example of the operation of the sales control unit 303 according to the embodiment of the present disclosure. The operation of the sales control unit 303 will be described with reference to FIG. 12.

In a case where a user who has logged into the marketplace desires to purchase NFT content, the sales control unit 303 connects to the user's wallet by using the wallet address of the user. The sales control unit 303 acquires a product purchase certificate (SBT) associated with the user's wallet (step S101).

The sales control unit 303 acquires, from the acquired product purchase certificate, information on the product purchased by the user (for example, product name, product code, price, purchase date, name of manufacturer, and the like). The sales control unit 303 specifies, using the acquired product information, the product corresponding to the NFT content that the user desires to purchase (step S102).

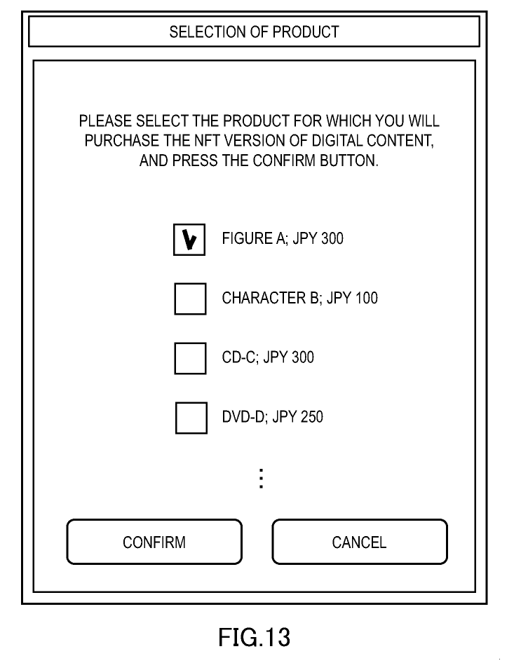

For example, the sales control unit 303 displays, on the terminal 70, a GUI such as that shown in FIG. 13 to specify the product corresponding to the NFT content that the user desires to purchase. In this case, the sales control unit 303 may present the price of the NFT content to the user, as shown in FIG. 13.

It should be noted that the sales control unit 303 may acquire the price of the NFT content by making an inquiry to the content management server 30 regarding the price of the NFT content. Alternatively, the price of the NFT content may be set to a price obtained by multiplying the price of the corresponding product by a predetermined coefficient.

In a case where the user finishes selecting the NFT content to be purchased, the sales control unit 303 performs verification of the product purchase certificate corresponding to the NFT content selected by the user (step S103).

Specifically, the sales control unit 303 performs verification relating to the issuer of the product purchase certificate. For example, the sales control unit 303 determines whether the ID of the issuer of the product purchase certificate (for example, the wallet address of the platform operator) is registered in advance as an ID of a platform operator with which transactions are conducted.

In a case where the ID of the issuer is registered, the sales control unit 303 determines that the product purchase certificate corresponding to the NFT content that the user desires to purchase is valid (determines that the verification of the product purchase certificate has succeeded). In a case where the ID of the issuer is not registered, the sales control unit 303 determines that the product purchase certificate corresponding to the NFT content that the user desires to purchase is invalid (determines that the verification of the product purchase certificate has failed).

In a case where the product purchase certificate is invalid (step S104, No branch), the sales control unit 303 notifies the user that the NFT content cannot be sold (notifies of sale unavailability; step S105).

In a case where the product purchase certificate is valid (step S104, Yes branch), the sales control unit 303 acquires from the content management server 30 the digital content to be sold to the user and the accompanying information related thereto. Specifically, the sales control unit 303 transmits, to the content management server 30 of the manufacturer or game manufacturer described in the product purchase certificate, a content provision request including a product code of the product corresponding to the digital content (step S106).

It should be noted that the sales control unit 303 refers to table information in which the name of the IP holder (manufacturer, game manufacturer) is associated with information (for example, an address) of the corresponding content management server 30, and specifies the content management server 30 to which the content provision request is to be transmitted.

The sales control unit 303 receives, from the content management server 30, a response (positive response, negative response) to the content provision request.

In a case where a negative response indicating that the digital content cannot be provided is received (step S107, No branch), the sales control unit 303 notifies the user that the NFT content cannot be sold (notifies of sale unavailability; step S105).

In a case where a positive response indicating that the digital content can be provided is received (step S107, Yes branch), the NFT content is sold to the user (step S108).

The user pays the price of the NFT content using cryptocurrency such as Bitcoin or Ethereum. Alternatively, a credit card or electronic money may be used for payment of the price of the NFT content.

It should be noted that all or part of the price for the NFT content paid by the user is paid to the corresponding IP holder (manufacturer, game manufacturer, or the like).

In a case where settlement relating to the sales price for the NFT content has been completed, the sales control unit 303 issues the NFT of the NFT content (step S109). The sales control unit 303 issues the NFT of the digital content acquired from the content management server 30 by using a smart contract.

Here, a person in charge of the platform business operator, or the like, creates in advance the smart contract for issuing the NFT of the NFT content. The person in charge, or the like, deploys the smart contract to the blockchain.

The sales control unit 303 issues the NFT of the NFT content by using the smart contract for NFT issuance.

The smart contract for NFT issuance issues an NFT in which the purchaser of the NFT content is the owner, and which includes, as metadata, information relating to the NFT content (for example, the name of the corresponding product, the name of the manufacturer, or the like). It should be noted that the NFT content and accompanying information are stored in storage of the NFT management server 40 that is accessible from the outside. By execution of the smart contract for NFT issuance, a link to storage in which the NFT content or the like is stored is described in the NFT.

In this way, the sales control unit 303 has a function as an acquisition means and a function as a generation means. The acquisition means acquires a 3D model corresponding to a product purchased by the user and accompanying information thereof. The accompanying information includes, for example, size information which is information serving as a standard for the size of the product in the metaverse space. The generation means generates (issues) an NFT (Non-Fungible Token) for the acquired 3D model by using the acquired 3D model and accompanying information (for example, size information). For example, the generation means manages the 3D model and accompanying information (size information) acquired from the content management server 30 so as to be externally available, and generates an NFT in which the purchaser of the product is the owner.

It should be noted that the sales control unit 303 may generate an NFT for the 3D model acquired from the IP holder (content management server 30) by using not only size information but also whole-body information and appearance information described later.

The provision control unit 304 is means for executing control relating to provision of NFT content and accompanying information thereof. In a case where an external server (for example, the metaverse server 60) accesses storage in accordance with a link described in the NFT of the NFT content, the provision control unit 304 externally provides the NFT content and accompanying information stored in the storage.

In other words, the provision control unit 304 has a function as a utilization means for controlling the 3D model for which the NFT has been generated so as to be available in the metaverse space. The provision control unit 304 provides the 3D model for which the NFT has been generated and accompanying information thereof to the metaverse server 60 in response to a request from the metaverse server 60. The provided 3D model and accompanying information (for example, size information) are used in the metaverse server 60.

The storage unit 305 is means for storing information necessary for the operation of the NFT management server 40.

It should be noted that the NFT management server 40 includes a processing module for allowing the user to browse purchased NFT content. A more detailed description of the processing module for allowing the relevant user to browse purchased NFT content will be omitted.

### [Metaverse Server]

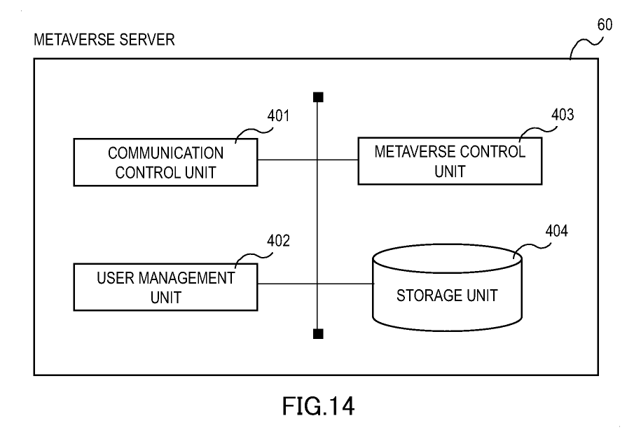

FIG. 14 is a diagram illustrating an example of a processing configuration (processing modules) of a metaverse server 60 according to an example embodiment disclosed in the present application. Referring to FIG. 14, the metaverse server 60 includes a communication control unit 401, a user management unit 402, a metaverse control unit 403, and a storage unit 404.

The communication control unit 401 is means for controlling communication with other apparatuses. For example, the communication control unit 401 receives data (packets) from the terminal 70. In addition, the communication control unit 401 transmits data to the terminal 70. The communication control unit 401 gives data received from other apparatuses to other processing modules. The communication control unit 401 transmits data acquired from other processing modules to other apparatuses. In this way, other processing modules transmit and receive data to and from other apparatuses via the communication control unit 401. The communication control unit 401 includes a function as a receiving unit for receiving data from other apparatuses, and a function as a transmitting unit for transmitting data to other apparatuses.

The user management unit 402 is means for performing control and management related to a user.

The user management unit 402 acquires information such as a name, a gender, a date of birth, and login information (ID, password) from a user who has accessed a predetermined website (for example, a user registration site). In addition, the user management unit 402 acquires a wallet address. The user management unit 402 stores the acquired name, login information, wallet address, or the like in a predetermined database.

The metaverse control unit 403 is means for performing control related to a metaverse (virtual space). Specifically, the metaverse control unit 403 implements a metaverse platform. The metaverse control unit 403 generates an avatar of the user and causes the generated avatar to operate in accordance with an operation of the user.

In addition, the metaverse control unit 403 performs control for using NFT content purchased by the user in a metaverse space (metaverse platform).

In a case where a user who has logged into an account performs a predetermined operation (for example, pressing an NFT content acquisition button), the metaverse control unit 403 acquires NFT content possessed by the user.

Specifically, the metaverse control unit 403 connects to a wallet of the user using a wallet address of the user. The sales control unit 303 acquires NFTs of respective NFT contents associated with the wallet of the user.

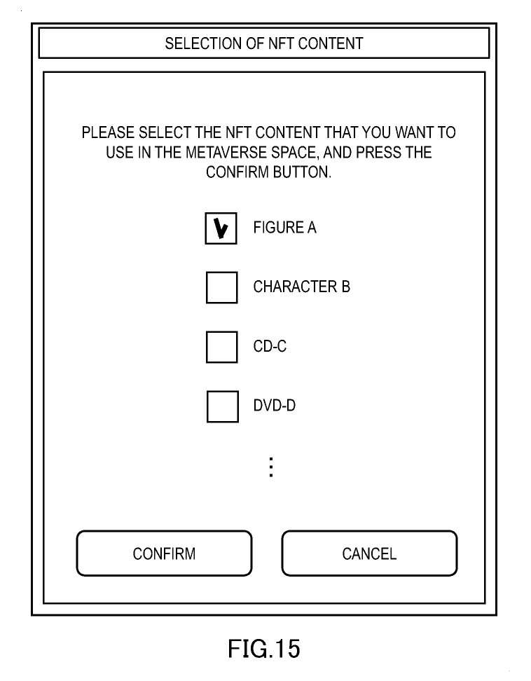

In a case where at least one or more NFTs owned by the user are acquired, the metaverse control unit 403 displays, on a terminal 70, a list of NFT contents possessed by the user using information acquired from the acquired NFTs. For example, the metaverse control unit 403 displays, on the terminal 70, a GUI as shown in FIG. 15, thereby enabling the user to select NFT contents desired to be brought into a metaverse space.

In a case where the user selects NFT contents to be brought into the metaverse space, the metaverse control unit 403 accesses a storage at a link destination described in an NFT corresponding to the NFT contents acquired by the user, and acquires the NFT contents and accompanying information.

In a case where the NFT contents and accompanying information are acquired, the metaverse control unit 403 uses the acquired NFT contents and accompanying information in the metaverse space.

A specific example related to the use of NFT contents will be described below.

It should be noted that a detailed description related to the implementation of a metaverse space (metaverse platform) by the metaverse control unit 403 will be omitted. This is because the implementation of the metaverse space is obvious to those skilled in the art and is different from the gist of the present application disclosed.

The storage unit 404 is means for storing information necessary for the operation of the metaverse server 60.

### Specific Example 1 of Use of NFT Contents

Next, a specific example related to the use of NFT contents will be described. Here, a case will be described in which a user utilizes a character purchased in a 3D game in a metaverse space

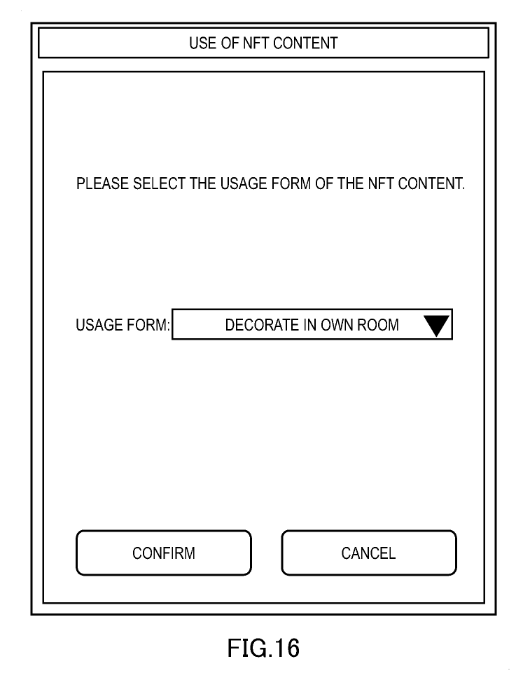

The metaverse control unit 403 acquires, from the user, a usage method (usage form) of the NFT contents selected by the user before and after the acquisition of the NFT contents. For example, in a case where NFT contents (3D model) corresponding to a game character are selected, the metaverse control unit 403 displays, on the terminal 70, a GUI as shown in FIG. 16.

The metaverse control unit 403 presents the user with options for usage forms corresponding to the type of NFT contents selected by the user. For example, in a case where NFT contents (3D model) of a character are acquired, the metaverse control unit 403 presents the user with options related to the usage form of the NFT contents, such as "decorate in one's room" or "use as an avatar."

The metaverse control unit 403 utilizes, on the metaverse, the NFT contents selected by the user in the usage form selected by the user.

Specifically, the metaverse control unit 403 performs control for using, in the metaverse space, a 3D model of a character acquired from an IP holder via the NFT management server 40. More specifically, the metaverse control unit 403 converts the NFT-ized 3D model so that it can be used on the metaverse space.

At that time, the metaverse control unit 403 uses, in the metaverse space, the 3D model of the character together with size information related to the size in a case of modeling the character in the metaverse space.

In other words, the metaverse control unit 403 acquires the NFT contents (3D model of the character) and the size information, which is accompanying information, from an IP holder of the NFT contents.

Here, the size information is information indicating a size standard in the metaverse space for the 3D model of the character. For example, the size information is set to a value assuming that the character exists in the real world. For example, for a humanoid character, the size information is set to 180 cm, and for a monster character, the size information is set to 3 m.

In this way, the metaverse control unit 403 acquires 3D shape information of the character used in a 3D game (data for three-dimensionally displaying the character) and the size information related to the size in a case where the character is brought into the metaverse space.

In a case where 3D shape information and size information of a character purchased by the user in a game are acquired, the metaverse control unit 403 uses the 3D shape information and the size information to use NFT-ized content (3D model of the character) in the metaverse space.

For example, the metaverse control unit 403 converts the acquired 3D model of the character into a 3D model having a size specified by the size information. It should be noted that, in the metaverse space, the height of the user is often used as the height of the avatar, and the metaverse control unit 403 may determine the size of the character to be brought into the metaverse space using the ratio between the height of the user and the height (number of pixels) of the avatar, and convert it into a 3D model to be used in the metaverse space.

For example, in a case where the height of the user is 180 cm and the size information of the character is set to 180 cm, the metaverse control unit 403 may convert the NFT-ized 3D model into a 3D model having the same height as the avatar of the user (character used in the metaverse space).

In a case where a 3D model to be used in the metaverse space is obtained, the metaverse control unit 403 uses the 3D model in the usage form designated by the user.

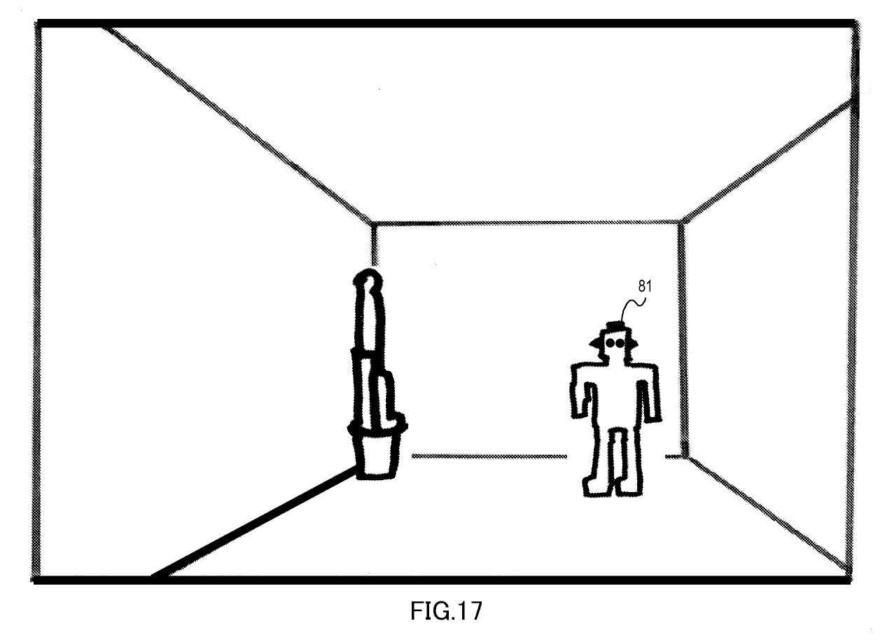

For example, in a case where the character purchased in the game is decorated in the user's own room as described above, the metaverse control unit 403 displays, on the terminal 70, a screen as shown in FIG. 17. In FIG. 17, the room of the user is shown, and the character 81 is placed in the room.

The metaverse control unit 403 may allow the user to move the character 81 placed in the room to any desired location. Alternatively, the metaverse control unit 403 may use the NFT contents in a usage form different from the original usage form in accordance with an operation (request) or the like of the user. For example, the metaverse control unit 403 may reduce the life-size character and place the character in the room like a figure in the real world.

As described above, the metaverse server 60 may use the NFT contents (for example, a 3D model of the character) purchased by the user as an avatar of the user.

In this case, the metaverse control unit 403 generates an avatar having a height approximately equal to the height of the user by using the 3D model purchased by the user. The metaverse control unit 403 uses the generated avatar (avatar having the appearance of the character) as the avatar of the user in the metaverse space.

It should be noted that the metaverse server 60 can change the size of the NFT contents (3D model) purchased by the user in the metaverse space. At that time, an IP holder such as a game company may set restriction information related to the change of the size as accompanying information of the NFT contents.

For example, the content management server 30 may transmit to the NFT management server 40, together with the 3D model, restriction information such that a change of the size of the 3D model within a range of X times to Y times is permitted, but a change of the size outside the range is not permitted.

The metaverse control unit 403 changes the size of the 3D model within the range permitted by the IP holder and uses the newly generated 3D model in the metaverse space. For example, the metaverse control unit 403 may place a life-size character in the user's own room or may place a one-tenth scale character like a figure in the metaverse space in accordance with a selection or operation of the user.

In this way, the metaverse control unit 403 may change the size of the NFT contents (for example, a figure or a 3D model of a character) in using the NFT contents in the metaverse space (it may be changed from the size defined by the IP holder). At that time, the metaverse control unit 403 may acquire the range in which the change of the size of the NFT contents in the metaverse space is permitted. The metaverse control unit 403 may change the size of the NFT contents within the range in which the change of the size is permitted.

### Specific Example 2 of Use of NFT Contents

The content management server 30 may provide, to the metaverse server 60 via the NFT management server 40, whole body information and a plurality of appearance information as accompanying information associated with the 3D model.

The whole body information of the 3D model is, for example, information related to the height and weight in a case where it is assumed that the character exists in the real world. Alternatively, the whole body information may include all or part of information related to height (size information), weight, hairstyle (head), hair quality, face, clothing, UV (UV mapping), texture, shape key, rigging, or the like.

The appearance information of the 3D model is information related to the expression or pose of the 3D model (for example, a character). The information related to the expression of the character includes a face in a case where the character is pleased, a face in a case where the character is angry, or the like. The information related to the pose of the character includes information on the angle and position of each part (arms, legs) in each pose of the character (for example, raising a hand, sitting). In this way, the accompanying information of the 3D model may include a plurality of appearance information corresponding to a plurality of expressions and a plurality of poses.

Alternatively, the accompanying information of the 3D model may include effect information. The effect information of the character is information displayed in the background of the character in accordance with the emotion or situation of the character. For example, in the case of a state or emotion such as the character being angry, the character being sad, or the character bracing oneself, background information corresponding to the state or emotion is included in the effect information.

The metaverse server 60 can use the digital content (3D model of the character) in the metaverse space by using the accompanying information (whole body information, appearance information, effect information). For example, the metaverse control unit 403 may further use the acquired whole body information to convert the NFT contents (for example, a figure or a 3D model of a character) into a 3D model (NFT object) to be used in the metaverse space.

Alternatively, the metaverse control unit 403 may further use the acquired appearance information to generate an NFT object corresponding to the NFT contents. Specifically, the metaverse control unit 403 determines a display state of the 3D model corresponding to the NFT contents (3D model of the character) based on the whole body information and one of the plurality of appearance information. The 3D model is used in the metaverse space by the metaverse control unit 403.

Alternatively, the metaverse control unit 403 may make it possible for the user to vary the pose or the expression of the NFT contents (for example, a figure or a 3D model of a character) by using a plurality of pieces of appearance information. Specifically, the metaverse control unit 403 may change the appearance of the 3D model (character) displayed in the metaverse space in accordance with an operation of the user (avatar of the user) in the metaverse space. The metaverse control unit 403 may deform the 3D model by using a plurality of pieces of appearance information.

For example, the metaverse control unit 403 may make it possible to switch the pose of the character in the metaverse space like an articulated figure by using a plurality of pieces of appearance information (pose information). At that time, the metaverse control unit 403 may provide an interface enabling the user to grasp each part of the character with the hand (avatar of the user) and to change the part to a desired angle (pose).

For example, the metaverse control unit 403 may vary the expression of the character by changing the shape key based on pose A.

Alternatively, the metaverse control unit 403 may randomly select one piece of appearance information from among a plurality of pieces of appearance information (pose information) and determine a display state of the 3D model (3D model of a character to be used in the metaverse space) by using the selected one piece of appearance information.

It should be noted that the accompanying information of the NFT contents may include only one piece of appearance information. In such a situation, in a case where the user desires to use the character in the metaverse space with a pose different from the one piece of appearance information, the user may acquire appearance information different from the previously acquired appearance information by reacquiring the NFT contents of the same purchased product. That is, a user who desires to use the character or the like in the metaverse space with appearance information different from the appearance information of the already issued NFT contents only needs to purchase the NFT again for the same product. At that time, the content management server 30 only needs to transmit, to the NFT management server 40, the appearance information randomly selected from among prepared appearance information. In this way, a lottery element may be added to the appearance information accompanying the NFT contents. Alternatively, the content management server 30 may transmit specific appearance information to the NFT management server 40 in accordance with a season (specific season, period, time zone (daytime, nighttime), or the like).

Alternatively, a movable range is set for each joint of the 3D model of the figure or character, and the metaverse control unit 403 may determine the pose of the figure or character by randomly determining an angle for each joint from within the movable range.

It should be noted that an IP holder such as a figure manufacturer or a game manufacturer can set information on poses, expressions, or the like that can be set in the metaverse space as accompanying information of the digital content (3D model) in advance. For example, the IP holder may make it impossible to change the 3D model for its own products by an inappropriate combination.

For example, the IP holder may make it impossible to realize a combination (combination of an expression and a pose) that would impair the image of the character if captured in a screenshot or the like. Alternatively, the IP holder (content management server 30) may provide, as accompanying information, information related to expressions and poses that can be combined.

### Specific Example 3 of Use of NFT Contents

In a case where the acquired NFT contents are book data, sound source data, video data, or the like, the metaverse control unit 403 may arrange the NFT object corresponding to the book data or the like in the metaverse space.

In this case, an IP holder (content management server 30) that provides NFT contents corresponding to books, CDs, DVDs, or the like may externally provide appearance information and genre information related to the NFT contents of the books or the like as accompanying information.

The appearance information is information related to the appearance (exterior) of the product on which the NFT contents are based. The appearance information includes, for example, image data related to a cover, a spine, or the like of a book. Alternatively, the appearance information includes image data related to a jacket or a spine of a CD or DVD.

The genre information is information related to the genre of the product on which the NFT contents are based. For example, the genre information indicates whether or not the product corresponding to the NFT contents is a CD or a DVD. Alternatively, the genre information indicates whether or not the product corresponding to the NFT contents falls under any of a comic, a general book, or a paperback book.

The metaverse control unit 403 uses the acquired appearance information and genre information in a case of arranging the acquired NFT contents (for example, digital contents corresponding to a book, a CD, a DVD, or the like) in the user's own room.

Specifically, the metaverse control unit 403 generates a new NFT object (3D model) to be used in the metaverse space based on the appearance information and genre information of the NFT contents.

The metaverse control unit 403 selects a predetermined template (template of the 3D model) corresponding to the genre information. For example, the metaverse control unit 403 selects a template corresponding to the genre information from among a comic template, a paperback book template, a CD template, and a DVD template.

The metaverse control unit 403 generates a 3D model corresponding to the NFT contents that the user desires to bring into the metaverse space by mapping the appearance information (image data of the cover, image data of the spine) of the NFT contents to the selected template.

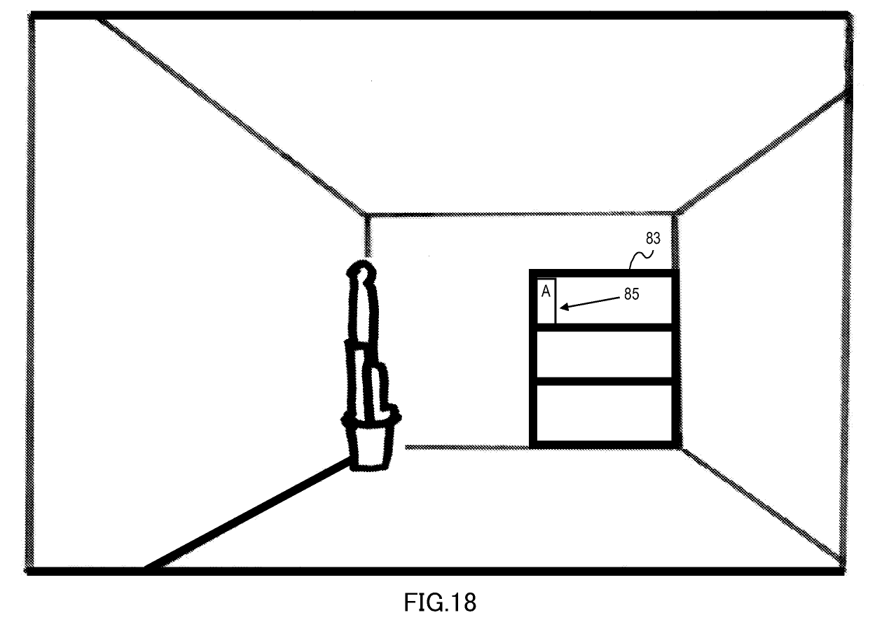

The metaverse control unit 403 uses the generated 3D model (3D model corresponding to a book, a CD, a DVD, or the like) in the metaverse space. For example, the metaverse control unit 403 arranges a 3D model 85 corresponding to a book on a bookshelf 83, as shown in FIG. 18.

Alternatively, the metaverse control unit 403 may arrange the 3D model corresponding to a CD or a DVD in a CD rack or the like in a form in which the jacket of the CD or DVD is visible to the user.

It should be noted that the appearance information may include a plurality of pieces of image data. In addition, the appearance information may include information (instructions) related to the handling of each piece of image data. For example, the appearance information may include information such as image data A = spine and image data B = front jacket.

In this way, the metaverse control unit 403 may include a function as an acquisition means, a function as a generation means, and a function as a utilization means. As the acquisition means, the metaverse control unit 403 acquires appearance information and genre information related to digital content corresponding to a product purchased by the user and NFT-ized. As the generation means, the metaverse control unit 403 generates a 3D model corresponding to the digital content based on the acquired appearance information and genre information. As the utilization means, the metaverse control unit 403 uses the generated 3D model in the metaverse space.

The metaverse control unit 403 may rearrange books (3D models corresponding to books or the like) or the like arranged in the metaverse space in accordance with an operation of the user (avatar of the user). For example, in a case where the user performs an action to grasp a book and the grasped book is placed in another location or between other books, the metaverse control unit 403 may arrange the grasped book (image data corresponding to the book) in another location or the like.

In this way, the metaverse control unit 403 may arrange the generated 3D model in a predetermined area (for example, a bookshelf or the like) in accordance with an instruction or a request from the user.

Alternatively, the metaverse control unit 403 may rearrange books, CDs, or the like according to a predetermined rule in response to an instruction or a request from the user. For example, the metaverse control unit 403 may rearrange books or the like in the order of the Japanese syllabary of the book titles or the like. Alternatively, the metaverse control unit 403 may rearrange books or the like in the order of purchase dates of products corresponding to the NFT contents.

Alternatively, the metaverse control unit 403 may rearrange and arrange a plurality of 3D models based on at least one of a market price, a number of transactions, and a number of sales of the NFT contents. In this case, the metaverse control unit 403 may acquire the market price and the number of sales of each NFT content by transmitting, to the NFT management server 40, the token ID of the NFT contents corresponding to each NFT object arranged on a bookshelf or the like. Alternatively, the NFT management server 40 may acquire the number of transactions from a transaction history of the NFT corresponding to each NFT content.

Alternatively, the metaverse control unit 403 may present, to the user, a difference between the NFT contents owned by the user (for example, sound source data corresponding to a CD) and the same type of NFT contents owned by another person. For example, the metaverse control unit 403 may present, to the user, a difference between the CD (sound source data corresponding to the purchased CD) owned by the user and the CD owned by a friend or a celebrity of the user.

Specifically, the metaverse control unit 403 presents, to the user, information (for example, a work title or a jacket photograph) of a CD (sound source data) owned by a person designated by the user and not owned by the user. At that time, the metaverse control unit 403 may present, to the user, a market price of the NFT contents (sound source data) corresponding to the CD not owned by the user.

Furthermore, in a case where the NFT contents are book data, sound source data, video data, or the like, the metaverse control unit 403 may make it possible to browse or play the book data, the sound source data, or the like in the metaverse space. In this case, the metaverse control unit 403 displays corresponding book data on a display or plays sound source data from a speaker in a case where the user (avatar of the user) touches the 3D model corresponding to a book or a CD.

As described above, the metaverse server 60 acquires digital content corresponding to a product purchased by the user, appearance information related to the appearance of the product, and genre information related to the genre of the product. The metaverse server 60 generates a 3D model corresponding to the acquired digital content based on the acquired appearance information and genre information. The metaverse server 60 uses the generated 3D model to control the acquired digital content so that it is available in the metaverse space.

### Specific Example 4 of Use of NFT Contents

The metaverse server 60 may make the NFT contents available to a third party other than the owner of the NFT contents. For example, the metaverse server 60 may control so that a user other than the owner of the sound source data or video data can also view or listen.

For example, the metaverse control unit 403 may control so that the user (avatar of the user) and a friend of the user (avatar of the friend) can watch the NFT contents together. For example, the metaverse control unit 403 may control so that a friend listed in the friend list of the user can also view or listen to the sound source data, video data, or the like of a CD, DVD, or the like while staying in the user's own room.

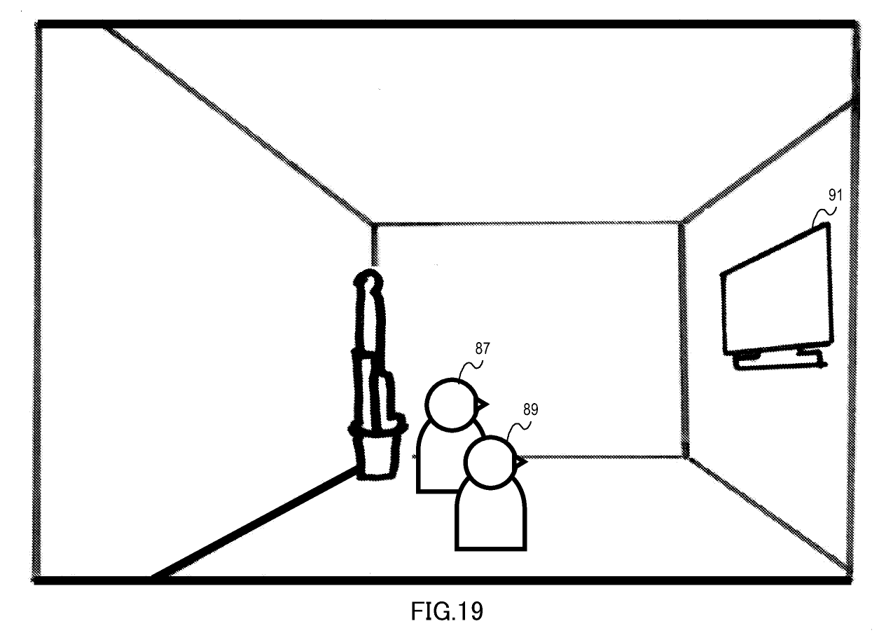

For example, as shown in FIG. 19, the metaverse control unit 403 may play back video data of a DVD selected by a user 87 on a display 91 placed in the room of the user 87, where the user 87 and a friend 89 of the user 87 are staying together.

An IP holder of a CD, a DVD, or the like may set information related to playback conditions of the NFT contents corresponding to the CD or the like as accompanying information of the NFT contents. For example, the content management server 30 may set playback condition information related to conditions for permitting playback of the NFT contents as the accompanying information.

For example, the content management server 30 externally provides, together with the NFT contents, playback condition information such as "viewable only by the owner," "viewable by the owner and one person other than the owner," or "no restriction on viewable users."

In a case where the playback condition information of the NFT contents (sound source data, video data) is acquired, the metaverse control unit 403 plays back the NFT contents in accordance with the playback condition information. For example, in a case where the owner's friend (second friend) enters the room of the owner during playback of the NFT contents for which "viewable by the owner and one person other than the owner" is set, the metaverse control unit 403 stops the playback of the NFT contents in accordance with the playback condition information of the NFT contents.

Alternatively, the metaverse control unit 403 may prohibit a second or subsequent friend from entering the room of the owner while the NFT contents are being played back. That is, the metaverse control unit 403 may perform control so that a third person becomes unable to enter the room of the owner while the NFT contents for which the above-described playback condition information is set are being played back.

In this way, the metaverse control unit 403 may acquire playback condition information related to playback conditions of NFT-converted audio data or video data, and may play back the NFT-converted audio data or video data in accordance with the acquired playback condition information.

An IP holder may permit playback control (for example, playback, pause, fast-forwarding, or the like of video data) of NFT contents only to an owner of the NFT contents, or may permit the playback control to a friend or the like who is viewing the NFT contents. The content management server 30 may set playback authority information related to playback authority of the NFT contents in supplementary information of the NFT contents.

For example, the content management server 30 externally provides playback authority information such as "playback control permitted only to the owner" and "playback control permitted also to a person other than the owner" together with the NFT contents.

The metaverse control unit 403 controls playback of the NFT contents in accordance with the acquired playback authority information of the NFT contents. For example, the metaverse control unit 403 displays an operation panel for video data on the display 91 shown in FIG. 19. The metaverse control unit 403 determines whether or not a person (avatar) operating the operation panel is a person permitted by the IP holder to perform playback control of the NFT contents. The metaverse control unit 403 controls playback of the NFT contents in accordance with the determination result.

Alternatively, playback authority of the NFT contents may be set in accordance with a selection made by the user. For example, the metaverse control unit 403 may perform control to grant playback authority of the NFT contents to a specific friend (a user registered as a friend) and not to grant playback authority to other friends. Through such operation of the metaverse control unit 403, it is possible to realize simultaneous viewing of anime or dramas in the metaverse space among friends.

The metaverse control unit 403 may perform control so that the user or the friend thereof can move the display 91 placed in the metaverse space (room of the user) to a desired position.

The IP holder may set rental information related to lending and borrowing of NFT contents in the accompanying information. For example, the content management server 30 may externally provide rental information such as "no rental restriction," "rental not allowed," "rental allowed only once," "rental allowed only to friends," and "rental period within one week," together with the NFT contents.

The metaverse server 60 determines whether or not rental of the NFT contents is permitted based on the rental information acquired together with the NFT contents. The metaverse control unit 403 manages, for each NFT content, the lending destination, number of times lent, lending period, and the like, and realizes lending and borrowing of NFT contents in accordance with the rental information.

In this way, the metaverse control unit 403 may acquire rental information related to lending and borrowing of NFT-audio data or NFT-video data. The metaverse control unit 403 may determine, in accordance with the acquired rental information, whether or not the user can lend the NFT-audio data or NFT-video data to a third party other than the user.

Alternatively, the metaverse control unit 403 may notify the owner of the status of lent NFT contents. For example, the metaverse control unit 403 may notify the owner in a case where the lent NFT contents are played back.

It should be noted that, in a case where the owner of NFT contents lends the NFT contents, the metaverse control unit 403 may acquire consent from the user that the lending of the NFT contents is for non-profit purposes. Similarly, in a case where the owner of the NFT content and another third party together view the NFT content, the metaverse control unit 403 may acquire from the user consent that the viewing (play back) of the NFT content is for a non-profit purpose.

### Specific Example 5 of Use of NFT Contents

The metaverse server 60 may automatically acquire digital content corresponding to products such as books, CDs, or DVDs.

In this case, the integrated management server 20, upon acquiring purchase history related to books, CDs, or the like from the service server 10-1 (EC site), transmits to the metaverse server 60 a product purchase certificate including information related to the purchased product and a wallet address of the purchaser or the like. The product purchase certificate may not necessarily be converted into an SBT.

The metaverse control unit 403 of the metaverse server 60 specifies a purchaser of a product from a wallet address included in a received product purchase certificate. In addition, the metaverse control unit 403 specifies an IP holder of a product (for example, a book or CD) purchased by the user based on information related to the purchased product included in the product purchase certificate.

The metaverse control unit 403, similar to the NFT management server 40, transmits a content providing request to the content management server 30 of the specified IP holder. The metaverse control unit 403 acquires digital content and accompanying information (appearance information and genre information) from the content management server 30.

The metaverse control unit 403, upon acquiring the digital content and the accompanying information, uses these pieces of information in the metaverse space. For example, the metaverse control unit 403 generates a 3D model corresponding to a book or CD from the accompanying information, and arranges the generated 3D model on a shelf or the like in the user's own room (my room).

It should be noted that the metaverse control unit 403 may use the digital content (for example, place a 3D model of a book or the like on a shelf) after obtaining consent from the user, or may use the digital content automatically.

The content management server 30 of the IP holder, upon receiving the content providing request from the metaverse server 60, may transmit only the accompanying information (appearance information, accompanying information) of the digital content to the metaverse server 60. The metaverse server 60 may arrange, in the user's private room, a 3D model corresponding to a book, CD, or the like by using the received accompanying information.

### Specific Example 6 of User of NFT Contents

The metaverse control unit 403 may control an object (NFT object) corresponding to NFT content arranged in the metaverse space so as to be distinguishable from other objects. More specifically, the metaverse control unit 403 may clearly indicate, in a manner recognizable to the user, that the NFT object is an object authorized by the right holder of the digital content that has been NFTized.

For example, in a case where an object within the user's field of view is an NFT object, the metaverse control unit 403 may display the above fact in the vicinity of the NFT object either continuously or temporarily.

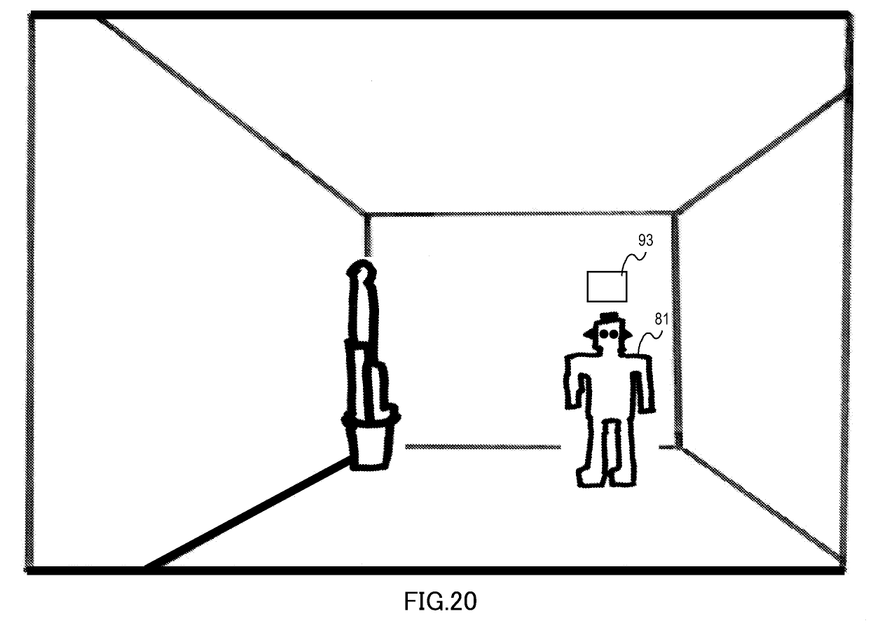

For example, in FIG. 20, in a case where the user (a user of the metaverse space including a user of the NFT content) gazes at a button 93 for a predetermined time, the metaverse control unit 403 displays information related to the corresponding NFT object (character 81).

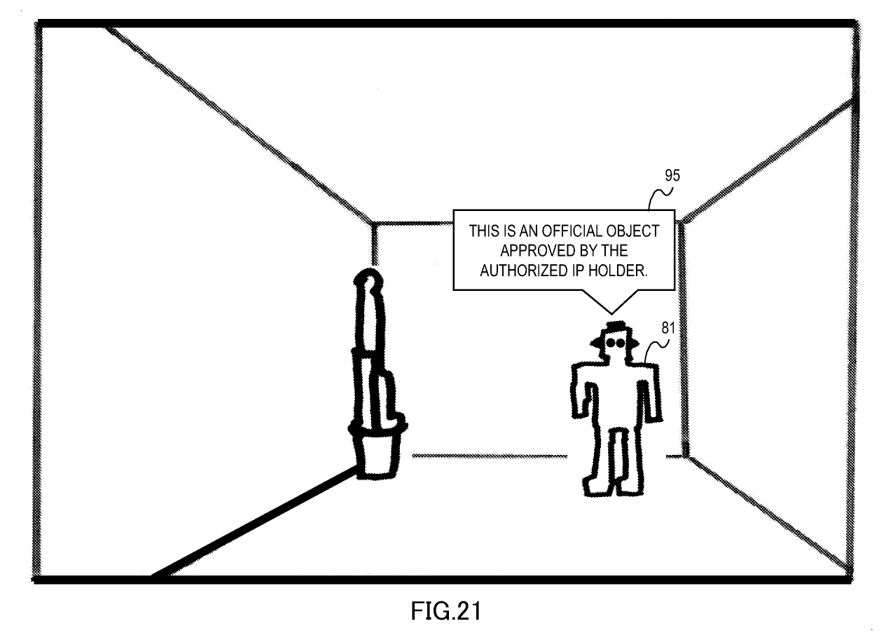

For example, the metaverse control unit 403 displays a popup 95 as shown in FIG. 21. The metaverse control unit 403 displays, in the popup 95, for example, an indication that the NFT object is content approved by an authorized IP holder.

It should be noted that the metaverse control unit 403 erases the displayed popup 95 after a predetermined time has elapsed from the display of the popup 95. Here, the time for which the user gazes at the button 93 shown in FIG. 20 in order to display the popup 95, and the time for which the popup 95 is displayed, can be set by the user via a settings menu or the like.

Alternatively, in a case where the button 93 for displaying information related to the NFT content becomes active (the user gazes at the button 93 for a predetermined time), the metaverse control unit 403 may erase the colors of objects other than the NFT object and display them in monochrome. The metaverse control unit 403 may indicate that the NFT object is an object authorized by the right holder by erasing the colors of objects other than the NFT object among at least one or more objects visible to the user.

Alternatively, in a case where the button 93 becomes active, the metaverse control unit 403 may cause the corresponding NFT object to emit light. In the example of FIG. 20, the metaverse control unit 403 may cause the character 81 to shine. The metaverse control unit 403 may display that the NFT object is an object authorized by the right holder by making the NFT object emit light.

As described above, the metaverse control unit 403 may include a function as an acquisition means and a function as a display means. The metaverse control unit 403 as the acquisition means acquires digital content that has been NFTized. The metaverse control unit 403 as the display means displays the NFT object corresponding to the NFTized digital content in the metaverse space. At that time, the metaverse control unit 403 (the display means) displays, in a manner recognizable to the user, that the NFT object is an object authorized by the right holder of the NFTized digital content.

Furthermore, the metaverse control unit 403 may include a function as a detection means. The metaverse control unit 403 as the detection means detects a predetermined action in the metaverse space performed by the user. For example, the metaverse control unit 403 detects whether or not the user has gazed at a predetermined object (the button 93) for a predetermined time or more. The metaverse control unit 403 displays that the NFT object is an object authorized by the right holder in a case where the user has gazed at the predetermined object for a predetermined time or more. For example, the metaverse control unit 403 displays the popup 95 for displaying information related to the NFTized digital content.

The metaverse control unit 403 may display, in place of or in addition to the button 93, a predetermined mark proving that the origin of the NFT content is an official IP holder, in the vicinity of the NFT object. The metaverse control unit 403 may display, using the predetermined mark, that the NFT object is an object authorized by the right holder.

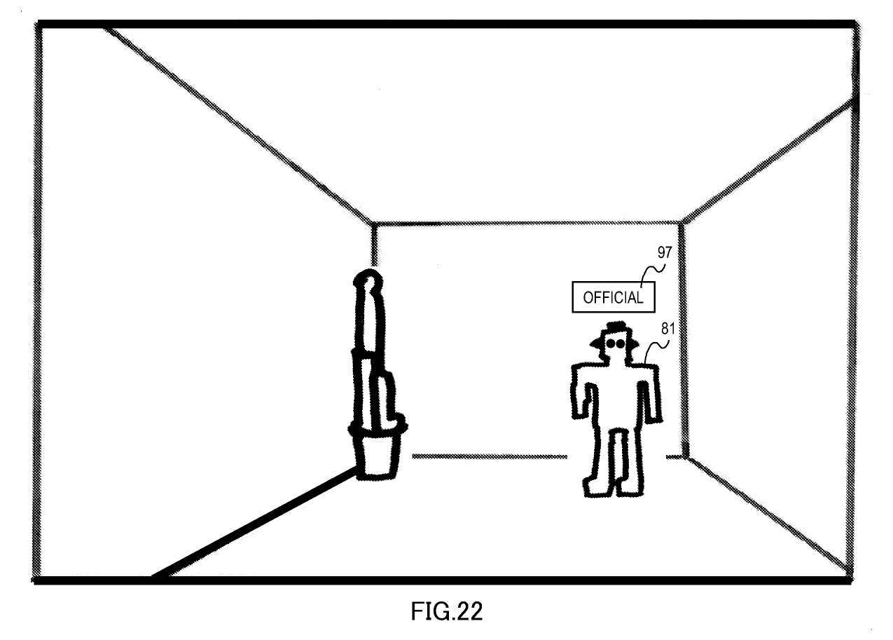

For example, the metaverse control unit 403 displays an official certification mark 97 in the vicinity of the character 81, as shown in FIG. 22.

It should be noted that the button 93 for displaying a popup and the official certification mark 97 are displayed not only on characters but also on other NFT objects. For example, in a case where NFT content is used for the avatar of the user, the button 93 and the official certification mark 97 are displayed in the vicinity of the avatar of the user. Alternatively, in a case where NFT content is used for an accessory worn by the user (avatar), the button 93 or the like is displayed in the vicinity of the accessory.

In this manner, the metaverse control unit 403 may display, by using the official certification mark, that an object in the metaverse space is an official NFT content generated based on a product purchase certificate proving that an official product or the like has been purchased in an EC site or the like. The official certification mark proves that the user actually owns a product corresponding to the NFT content.

In other words, content without backing by purchase of a product may be content illegally generated. Accordingly, in a case where content is used in the metaverse space, it is important that it be conveyed to the user that the content is approved by an IP holder who owns the intellectual property rights of the content. Against this background, the metaverse control unit 403 controls so that the user can visually recognize the fact that content used in the metaverse space is approved by the IP holder who owns the intellectual property rights of the NFT content.

The metaverse server 60 arranges an object corresponding to NFT-converted digital content in the metaverse space. The metaverse server 60 displays in the metaverse space that the arranged object is an object approved by a right holder who owns the intellectual property rights of the corresponding product. In addition, the metaverse server 60, upon detecting a predetermined action by the user in the metaverse space, displays in the metaverse space that the arranged object is an object approved by a right holder who owns the intellectual property rights of the corresponding product.

It should be noted that the NFT-converted content is digital content corresponding to a product purchased by the user in the real world, and is digital content generated as a result of the user actually purchasing the product (service).

In addition, regarding the use of the metaverse space for products such as CDs, it has been described that the CDs or the like are arranged in a room or that corresponding sound source data or the like is played back. However, the use of CDs or the like is not limited to this form, and for example, the appearance of CDs or the like may be used as a design for clothing (for example, a T-shirt) or towels worn by the avatar of the user. Alternatively, the appearance information of CDs or the like may be used in the manner of an acrylic stand.

### [Service Server]

A detailed description of the configuration and operation of the service server 10 will be omitted. After selling a product to the user, the service server 10-1 may store the purchase history of the sold product. Alternatively, the service server 10-2 may store the user's game play history (play history including purchase history of characters, items, and the like).

### [Wallet Server]

A detailed description of the configuration and operation of the wallet server 50 will be omitted. The wallet server 50 may issue a wallet address to the user.

### [Content Management Server]

A detailed description of the configuration and operation of the content management server 30 will be omitted. The content management server 30 stores the digital content for each product handled by own company and its accompanying information, and may transmit the digital content and the accompanying information in accordance with a request from the NFT management server 40.

More specifically, if no digital content or the like corresponding to the product code included in the content providing request exists, the content management server 30 transmits to the NFT management server 40 a negative response indicating that fact. In a case where digital content or the like of a product code included in the content providing request exists, the content management server 30 transmits to the NFT management server 40 a positive response indicating the fact, the positive response including the digital content and accompanying information thereof.

It should be noted that a figure manufacturer or the like registers in advance, in the content management server 30, the product codes, digital content, and accompanying information related to its own products.

### [Terminal]

Examples of the terminal 70 include a portable terminal device such as smartphones, HMDs, mobile phones, game machines, and tablets, and also computers (personal computers and notebook computers). The terminal 70 can be any apparatus or device insofar as it accepts user operations and is capable of communicating with the integrated management server 20 or the like. Further, since the configuration, and so on, of the terminal 70 is obvious to those skilled in the art, a detailed description will be omitted.

### [Operation of System]

Next, operations of the information processing system according to the first example embodiment will be described.

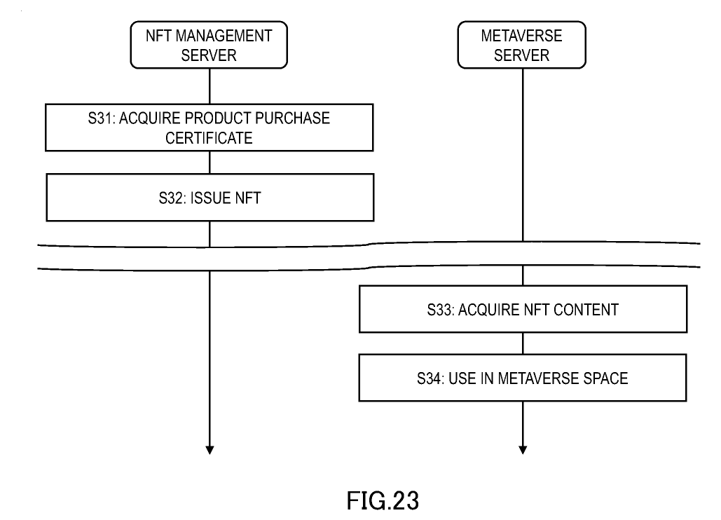

FIG. 23 is a sequence diagram illustrating an example of the operations of the information processing system according to the example embodiment disclosed in the present application. With reference to FIG. 23, the operations of the information processing system according to the first example embodiment will be described.

In a case where a user desires the issuance of a product purchase certificate, the NFT management server 40 acquires the product purchase certificate from the wallet of the user (step S31).

Furthermore, the NFT management server 40 acquires the digital content and the accompanying information of the product corresponding to the product purchase certificate that the user desires to issue from the content management server 30, and issues an NFT corresponding to the acquired digital content (step S32).

In a case where the user desires to use NFT content in the metaverse space, the metaverse server 60 acquires the NFT content and the accompanying information from the NFT management server 40 (step S33).

The metaverse server 60 uses the NFT content in the metaverse space by using the acquired NFT content and the accompanying information (step S34).

Next, variations according to the first example embodiment will be described.

### Variation 1

In the above example embodiment, the operation and the like of the information processing system have been described by taking, as an example, a game as an example of a service provided using a 3D model. However, a service using a 3D model is not limited to a game. For example, the provision of a metaverse space is also included in services using a 3D model.

In other words, NFT content such as a product purchased by a user in a metaverse space may be sold to the user. That is, the service server 10 may include the function of the metaverse server 60, or the metaverse server 60 may include the function of the service server 10.

More specifically, NFT content (3D model) of a product purchased in a first metaverse space may be used in a second metaverse space.

In addition, a target of content to be converted into an NFT is not limited to a character in a game or metaverse, but may be an item such as a weapon used in a game, or may be a building or the like appearing in the metaverse.

### Variation 2

NFT content (3D model) targeting a character obtained by a user through a paid lottery (so-called gacha) in a game may be sold.

Alternatively, in a case where the appearance of a character (so-called skin) is sold in a game, a 3D model of a character having the appearance of the sold skin may be sold as NFT content.

### Variation 3

A product corresponding to NFT content that can be purchased by a user may be a character, an item, or the like acquired by the user free of charge in a game. In this case, the integrated management server 20 may request the user to pay a certificate issuance fee in a case where a product purchase certificate for the character or the like acquired free of charge is issued.

Alternatively, the NFT management server 40 may request the user to pay an NFT issuance fee in the case of selling NFT content corresponding to a character or the like acquired free of charge by the user.

Alternatively, NFT content may be sold (transferred) completely free of charge to a user for some characters or the like. That is, the integrated management server 20 may not request the user to pay a product purchase certificate issuance fee, and the NFT management server 40 may not request the user to pay an NFT issuance fee, and free NFT content may be sold to the user.

### Variation 4

Even in a case where there is no application from a user, all or a part of a product purchased by a product purchaser may be automatically distributed as NFT content to the product purchaser. That is, NFT content may be distributed free of charge to the user without the user making a request to the integrated management server 20 for issuance of a product purchase certificate.

In this case, the metaverse server 60 may use NFT content purchased by the user and NFT content distributed free of charge without distinction in the metaverse space. In a case where NFT content is distributed free of charge, the metaverse server 60 may periodically or at predetermined timings access the wallet of the user to determine whether or not there is newly distributed NFT content. In a case where there is newly distributed NFT content, the metaverse server 60 may inquire of the user regarding whether or not the NFT content can be used.

### Variation 5

In order to prevent an act of repeatedly creating and deleting an account on a game server (so-called reset marathon), it may be set as a condition for purchasing NFT content such as a game character that the game has progressed for a predetermined period of time or more.

In this case, the integrated management server 20 acquires play history from the service server 10-2 (game server) and calculates the play time of the game based on the acquired play history. The integrated management server 20 does not issue a product purchase certificate related to a game character, item, or the like corresponding thereto in a case where the play time has not exceeded the predetermined time.

In addition, the integrated management server 20 may determine whether or not to issue a product purchase certificate based not on the total play time of the game but on the play time during a match (battle) in the game or the time during which a character is actually operated in the game. That is, the possibility of issuing a product purchase certificate for a character or the like appearing in the game may be determined in accordance with more active time in the game. By such an operation of the integrated management server 20, so-called idle play time accumulation can be prevented. In other words, the NFT management server 40 may determine whether or not to issue an NFT corresponding to a specific character based on the usage time (operation time by the user) of the specific character.

Alternatively, the integrated management server 20 may set a story (achievement of a predetermined event), trophy completion (acquisition of a title, medal, or the like), attainment of a specific rank (level) by a player, or the like as a purchase requirement of NFT content (an issuance requirement of a product purchase certificate). Alternatively, the integrated management server 20 may set the purchase requirements of NFT content by combining a plurality of elements among a plurality of elements such as play time, story development, trophy completion, and player rank. Alternatively, the integrated management server 20 may issue an NFT corresponding to a specific character, weapon, or the like in accordance with the fact that the number of uses of a specific character, the number of uses of a weapon, the number of uses of a specific technique, the amount of damage, the number of kills, or the like has reached a predetermined reference value.

### Variation 6

The NFT management server 40 may impose a time limit on the purchase of NFT content by a user. For example, the NFT management server 40 may sell NFT content for all or some of the products only during a predetermined period after the product has been purchased.

For example, only for a predetermined period after purchasing a game character or skin obtained through a paid lottery, the NFT management server 40 may sell NFT content (a 3D model of the corresponding character or the like) to the user. For example, a restriction may be set such that the user can purchase NFT content (a 3D model) within one month from the execution of the lottery.

In this case, the sales control unit 303 of the NFT management server 40 may refer to the sale date acquired from the product purchase certificate to determine whether or not to sell the NFT content, or may utilize dynamic NFTs or time-limited parameters to implement the above restriction.

### Variation 7

The NFT content that the user can purchase may change in accordance with changes in the product serving as the basis of the NFT content. For example, in a case where a character purchased by the user in a game grows as the game progresses, the user may be able to purchase, as NFT content, a 3D model after growth instead of the 3D model at the time of character purchase.

For example, the user performs a predetermined operation (for example, pressing a state reflection button) on a logged-in game server (the service server 10-2). The game server reflects the operation in the play history. At that time, the game server sets a product code and a level (state) of the character reflected in the latest state in the play history.

The integrated management server 20 acquires the play history from the game server. In a case where issuance of a product purchase certificate is requested for a character for which "state reflection" has been performed in the play history, the integrated management server 20 issues a product purchase certificate including the latest product code and level for the character.

In a case where NFT content is sold, the NFT management server 40 transmits a level (state) together with a product code of a character to the content management server 30 of a game manufacturer. The content management server 30 transmits a 3D model corresponding to the acquired product code and level to the NFT management server 40. The NFT management server 40 sells, to the user, a 3D model corresponding to the latest state (level) of the character as NFT content.

### Variation 8

The metaverse server 60 may utilize NFT content in two dimensions instead of utilizing it in three dimensions. For example, the metaverse control unit 403 converts a 3D model into photo data (image data) by a photo mode or the like. In addition, after converting the 3D model into photo data, the metaverse control unit 403 may further cut out the photo data into an arbitrary shape. The metaverse control unit 403 can obtain photo data cut into an arbitrary shape and can utilize the photo data cut into an arbitrary shape in a metaverse space. In addition, the metaverse control unit 403 may display the photo data as an acrylic stand, a holospray, or the like in the metaverse. Alternatively, the metaverse control unit 403 may use the photo data or the photo data cut into an arbitrary shape as an icon of a user account. By such an operation of the metaverse control unit 403, the user can use, as an icon, an image in which rights such as copyright are officially clarified rather than an unauthorized use of an image or the like.

### Variation 9

An IP holder may set whether or not to permit derivative works related to its own product with respect to digital content. For example, the content management server 30 transmits information related to derivative works together with digital content as accompanying information to the NFT management server 40. The metaverse server 60 acquires permission or non-permission for derivative works related to NFT content (for example, a figure or a 3D model of a character) acquired via the NFT management server 40.

The metaverse control unit 403 of the metaverse server 60 displays information related to secondary creation (permission for secondary creation, non-permission for secondary creation). For example, the metaverse control unit 403 displays information related to secondary creation in the popup 95 as shown in FIG. 21.

Alternatively, the information related to secondary creation may be described in a product purchase certificate corresponding to a product. Specifically, an IP holder such as a figure manufacturer transmits information related to secondary creation together with information related to its own product (for example, a product name or a product code) to an EC site or the like. The EC site or the like stores a purchase history including the information related to the secondary creation.

In a case where the integrated management server 20 acquires a purchase history including the information related to the secondary creation, the integrated management server 20 issues a product purchase certificate (SBT) including the information related to the secondary creation.

In a case where the product purchase certificate includes the information related to the secondary creation, the NFT management server 40 that sells NFT content issues an NFT in which the information is described in metadata.

The metaverse server 60 may display, in the popup 95, the information related to the secondary creation described in the NFT of the NFT content.

### Variation 10

The NFT content may be content generated by a business operator other than an IP holder. For example, a business operator licensed by the IP holder may generate NFT content. In addition, in a case where a licensed business operator generates NFT content, information indicating this fact may be provided as accompanying information together with the NFT content to the metaverse server 60 or the like.

In this case, the metaverse control unit 403 of the metaverse server 60 may display, in the popup 95 as shown in FIG. 21 or the like, the fact that the NFT content was generated by a licensed business operator. That is, the metaverse server 60 may display, in a manner enabling a user to visually recognize the fact, information related to NFT content generated by a licensed business operator.

### Variation 11

An IP holder may set tag information (attribute information) of a character as accompanying information of NFT content (a 3D model of the character). For example, the IP holder may set, as tag information in the accompanying information of NFT content, information related to the strength of a character during battle (for example, a strength level) or information related to the origin of the character (for example, a game title name). Alternatively, the accompanying information may include the number of times a character has been drawn by a user in a social game, the number of times the level limit of the character has been exceeded (limit break count), or parameters (color variations of the character, personality, individual values, size (minimum value, maximum value), and weight). Alternatively, the accompanying information may include elements described in a game banner (for example, the number of kills by weapon type, the number of game plays, the number of kills, the amount of damage, and the like).

The metaverse control unit 403 of the metaverse server 60 may display, in a visually recognizable manner to a user, the tag information related to the strength or origin of the character. For example, the metaverse control unit 403 may display the information related to the strength in a popup 95 as shown in FIG. 21.

### Variation 12

The metaverse server 60 basically displays NFT content that is within a range visible to a user (an avatar of the user). In other words, the metaverse control unit 403 does not display NFT content existing beyond a wall in a manner visible to the user. However, by changing the settings, the metaverse control unit 403 may display the existence of the NFT content (for example, a 3D model of a character) beyond the wall in a manner enabling the user to recognize it.

For example, the metaverse control unit 403 may faintly display an NFT character existing beyond the wall (displaying it with blurred boundaries). Alternatively, the metaverse control unit 403 may display the NFT content with low opacity. Alternatively, the metaverse control unit 403 may display a shadow of the NFT content. Alternatively, the metaverse control unit 403 may highlight the NFT content beyond the wall in noticeable colors such as red, yellow, or blue. That is, the metaverse control unit 403 may emphasize NFT content existing beyond the wall to enhance its visibility. Alternatively, the metaverse control unit 403 may make the NFT content relatively more noticeable by lowering the brightness or saturation of other objects that are not NFT content.

Alternatively, in consideration of a case where the user is color blind, the metaverse control unit 403 may allow the colors used for NFT content existing beyond the wall to be changed to colors that are easier to see. The change may be customizable by the user.

Alternatively, the metaverse control unit 403 may control the above-mentioned official certification mark to be visible beyond the wall. In this case, the metaverse control unit 403 may change the size of the official certification mark in accordance with the distance between the user and the NFT content. The user may grasp the distance to the NFT content based on the size of the official certification mark. That is, the official certification mark of NFT content located far from the user is displayed small, and the official certification mark of NFT content located near the user is displayed large.

### Variation 13

In the above example embodiment, the NFT management server 40 has been described in a case of converting digital content of a product purchased by the user (for example, a figure or a character) into an NFT. That is, the NFT management server 40 issues an NFT of digital content (for example, a 3D model) corresponding to a product purchased by the user.

However, the NFT management server 40 may issue an SBT corresponding to digital content corresponding to a product purchased by the user instead of the NFT. The NFT management server 40 may generate an SBT for a product purchased by the user (for example, a figure or a character) instead of content converted into an NFT (for example, a 3D model of a character). That is, digital content (a 3D model) purchased by the user may be made non-resalable.

Alternatively, the NFT management server 40 may allow the user to select whether to convert digital content for a product purchased by the user into an NFT or into an SBT. In this case, the NFT management server 40 may set a price difference between NFT-converted digital content and SBT-converted digital content. For example, the NFT management server 40 may set the price of NFT-converted digital content higher than the price of SBT-converted digital content.

### Variation 14

The metaverse server 60 may notify an IP holder or the like in a case where an object that appears to infringe an intellectual property right is found in a metaverse space. For example, the metaverse server 60 inputs an object in the metaverse space into a learning model and determines whether or not the object is similar to an existing character or the like. The metaverse server 60 may notify the IP holder (the content management server 30) in a case where an object used in the metaverse space is similar to an existing character or the like. The IP holder investigates the notified object and takes appropriate action (for example, giving a warning to the user or the like) based on the investigation result.

### Variation 15

In the above example embodiment, the operation of the information processing system and the like has been described on the premise that the service server 10 is a server that provides an e-commerce site or a game server. However, the service server 10 may be a server that provides a video distribution service.

In this case, a 3D model of a distributor's avatar (so-called VTuber) may be sold to a viewer as NFT content. At that time, a purchase availability of the 3D model may be determined, or a 3D model that can be purchased may be limited, in accordance with a membership rank of a distribution service. For example, only a user who has been subscribed to the highest rank for a predetermined period or more (for example, three months) may be able to purchase NFT content corresponding to the distributor's avatar.

### Variation 16

In the above example embodiment, the integrated management server 20 has been described in connection with a case where the integrated management server 20 acquires a purchase history of a product and a play history of a game by logging into a service server 10 linked with an account. However, the integrated management server 20 may acquire the purchase history and the play history from the service server 10 without linking the account. For example, the service server 10 transmits information of the purchased product and a wallet address of the user to the integrated management server 20 in a case where the user purchases the product. The integrated management server 20 may identify the user using the received wallet address and store the purchase history in the account of the identified user.

### Variation 17

In the above example embodiment, the integrated management server 20 has been described in connection with a case where the integrated management server 20 issues a product purchase certificate in accordance with a request from the user. However, the integrated management server 20 may issue the product purchase certificate in accordance with having acquired the purchase history of the product from the service server 10. That is, a purchase certificate control unit 203 of the integrated management server 20 may automatically issue the product purchase certificate.

### Variation 18

The NFT management server 40 may set a limitation on the number of purchases of NFT content. Specifically, the NFT management server 40 may sell one NFT content per product.

In this case, the NFT management server 40 may set "NFT content sold" in a product purchase certificate corresponding to the product for which the NFT content has been sold. The NFT management server 40 may make the sale of the NFT content impossible based on the product purchase certificate in which "NFT content sold" has been set.

### Variation 19

In the above example embodiment, the integrated management server 20 has been described in connection with a case where the integrated management server 20 issues a product purchase certificate as an SBT. However, the integrated management server 20 may issue a product purchase certificate in another format.

Specifically, the purchase certificate control unit 203 of the integrated management server 20 may issue a digital certificate using a Public Key Infrastructure (PKI) as the product purchase certificate. Alternatively, the purchase certificate control unit 203 may issue a credential certificate (VCs; Verifiable Credentials), whose content can be verified online, as the product purchase certificate.

In a case where the digital certificate or the credential certificate is issued as the product purchase certificate, the NFT management server 40 verifies an electronic signature appended to these certificates. If the verification of the electronic signature is successful, the NFT management server 40 issues the NFT of the NFT content.

In addition, in a case where the digital certificate using the PKI or the credential certificate is issued as the product purchase certificate, these certificates may be managed by the wallet of the user, or may be managed in an account of the integrated management server 20 or the NFT management server 40.

In a case where the integrated management server 20 manages the product purchase certificate of the user, the NFT management server 40 requests the integrated management server 20 to provide the product purchase certificate. Specifically, the sales control unit 303 of the NFT management server 40 transmits a wallet address of the user to the integrated management server 20. The integrated management server 20 identifies the user who wishes to purchase the NFT content using the wallet address and transmits the product purchase certificate stored in the account of the identified user to the NFT management server 40.

In a case where the NFT management server 40 manages the product purchase certificate of the user, the purchase certificate control unit 203 of the integrated management server 20 transmits the issued product purchase certificate together with the wallet address of the user to the NFT management server 40. The user management unit 202 of the NFT management server 40 identifies the user who has received the issuance of the product purchase certificate using the wallet address and stores the received product purchase certificate in the account of the identified user.

### Variation 20

A system configuration shown in FIG. 3 is an example. For example, the integrated management server 20 operated by a platform business operator may provide a wallet service. That is, the integrated management server 20 may include a function of a wallet server 50.

Alternatively, in the above example embodiment, the NFT management server 40 has been described in connection with a case where the NFT management server 40 issues an NFT of NFT content. However, the integrated management server 20 may issue the NFT of the NFT content. That is, the integrated management server 20 may include a function of the NFT management server 40.

As described above, the metaverse server 60 according to the first example embodiment acquires information related to the size in a case where the user brings a product such as a purchased figure into the metaverse space. For example, the metaverse server 60 acquires the information related to the size from a content management server 30 of an IP holder that manages intellectual property rights related to the product such as the figure. The metaverse server 60 converts the 3D model corresponding to the figure or the like into the 3D model for use in the metaverse space using the acquired size information, and uses the converted 3D model in the metaverse space. At that time, the above size information is set to an appropriate size determined by a right holder of the figure or the like (appropriate size of the figure or the like in the metaverse space), so that the figure or the like is not used at a size unintended by the right holder. As a result, products such as figures and characters used in games are appropriately used in the virtual space.

In addition, the metaverse server 60 acquires NFT-converted digital content (for example, a 3D model) corresponding to a product such as a figure purchased by the user from an IP holder. The metaverse server 60 displays an object corresponding to the acquired digital content in the metaverse space. At that time, the metaverse server 60 indicates that the object displayed in the metaverse space is an object approved by a right holder of the NFT-converted digital content. Through such an operation of the metaverse server 60, a right holder having intellectual property rights for a figure or the like can monitor whether or not a character or the like of its own product is illegally used in the metaverse space. As a result, it is possible to prevent content corresponding to products such as figures and characters used in games from being illegally used in the virtual space.

Furthermore, the metaverse server 60 acquires information related to an appearance of the product and information related to a genre of the product in a case where the user brings a product such as a purchased book or CD into the metaverse space. For example, the metaverse server 60 acquires the appearance information and the genre information from a content management server 30 that manages intellectual property rights related to the product such as the book. The metaverse server 60 generates a 3D model corresponding to the book or the like purchased by the user using the acquired appearance information and genre information. The metaverse server 60 uses the generated 3D model in the metaverse space. At that time, the above appearance information and genre information are set to an appropriate appearance and genre determined by a right holder of the book or the like, so that the book or the like is not used with an appearance unintended by the right holder. As a result, products such as books and CDs are appropriately used in the virtual space.

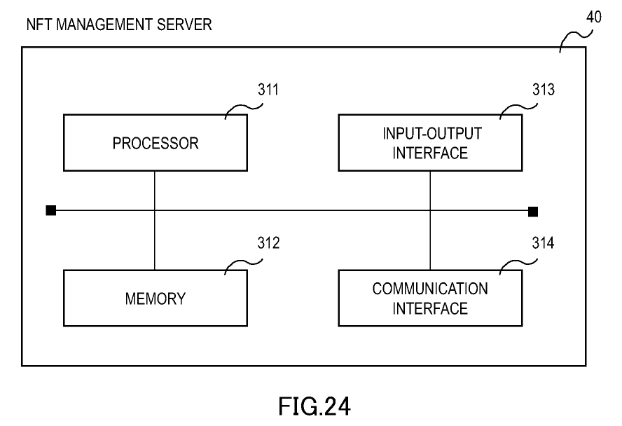

Next, a hardware configuration of an individual apparatus that constitutes the information processing system will be described. FIG. 24 is a diagram illustrating an example of a hardware configuration of the NFT management server 40.

The NFT management server 40 can be configured by an information processing apparatus (a so-called computer) and has a configuration illustrated as an example in FIG. 24. For example, the NFT management server 40 includes a processor 311, a memory 312, an input-output interface 313, a communication interface 314, and so on. The above-described components such as the processor 311 are connected via an internal bus or the like and are configured to be capable of communicating with each other.

However, the configuration shown in FIG. 24 is not intended to limit the hardware configuration of the NFT management server 40. The NFT management server 40 may include hardware not illustrated in the figure, and may omit the input-output interface 313 as needed. In addition, the number of components such as the processor 311 included in the NFT management server 40 is not intended to be limited to the example shown in FIG. 24, and, for example, a plurality of processors 311 may be included in the NFT management server 40.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), or the like. The memory 312 stores an OS program, an application program, and various kinds of data.

The input-output interface 313 is an interface for a display apparatus and an input apparatus not illustrated. The display apparatus is, for example, a liquid crystal display or the like. For example, the input apparatus is an apparatus that receives user operations, and examples of the input apparatus include a keyboard and a mouse.

The communication interface 314 is a circuit, a module, and so on for performing communication with other apparatuses. For example, the communication interface 314 includes a NIC (Network Interface Card) or the like.

The functions of the NFT management server 40 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present disclosure can be embodied as a computer program product. In addition, the above program may be updated by downloading a program via a network or by using a storage medium in which a program is stored. In addition, the above processing modules may be realized by semiconductor chips.

It should be noted that the service server 10, the integrated management server 20, the content management server 30, the wallet server 50, and the metaverse server 60, and the like can also be configured by an information processing apparatus similarly to the NFT management server 40, and the basic hardware configuration thereof is not different from that of the NFT management server 40, so the description will be omitted.

The NFT management server 40, which is an information processing apparatus, includes a computer and can realize its functions by causing the computer to execute a program. In addition, the NFT management server 40 executes a control method of the NFT management server 40 by using the program. Similarly, the integrated management server 20 is equipped with a computer, and the functions of the integrated management server 20 can be realized by executing a program on the computer. In addition, the integrated management server 20 executes a control method of the integrated management server 20 by using the program.

### [Variations]

It should be noted that the configurations, operations, and the like of the information processing system described in the above example embodiment are examples, and are not intended to limit the configurations of the system or the like.

In the above example embodiment, the configuration and the operation of the information processing system have been described taking, as an example, a case where NFT-converted content is used in the metaverse space. However, the digital content used in the metaverse space may not be NFT-converted. If the user has the authority to use the product in the metaverse space, the metaverse server 60 may use digital content (a 3D model) corresponding to the product in the metaverse space. In this case, the metaverse server 60 may acquire a product purchase certificate from the wallet of the user and request a content management server 30 to provide digital content corresponding to a product code described in the product purchase certificate.

In the above example embodiment, it has been described that the user logs into an EC site or a game server via the integrated management server 20. However, the user may log into the EC site or the like directly.

In the above example embodiment, a case has been described in which the integrated management server 20 issues a product purchase certificate. However, the EC site or the game server where the user purchased the product may issue the product purchase certificate.

In the above example embodiment, in a case where the user wishes to purchase NFT content, the NFT management server 40 has been described in connection with a case of verifying a product purchase certificate corresponding to the product selected by the user. However, the NFT management server 40 may perform verification in advance for each of a plurality of product purchase certificates owned by the user, and display a list of products for which the user can purchase NFT content. That is, the NFT management server 40 may exclude NFT content that the user cannot purchase and allow the user to select the NFT content (select the NFT content to purchase) using a GUI similar to FIG. 13.

In the above example embodiment, a case has been described in which the NFT management server 40 stores main data (actual data) and accompanying information of the NFT content. However, the main data and the like of the NFT content may be stored in the content management server 30 of the IP holder or may be stored in the integrated management server 20. Alternatively, the main data and the like of the NFT content may be stored in a blockchain. Alternatively, accompanying information of the NFT content may be described in metadata of the NFT.

The integrated management server 20 may manage an issuance status of the product purchase certificate (a purchase status of NFT content) in an account of each user. By managing the issuance status of the product purchase certificate of the user, the integrated management server 20 may display, in the GUI shown in FIG. 10, a product for which the certificate has not been issued and a product for which the certificate has been issued in a manner that the user can distinguish between them. For example, the integrated management server 20 may display "Certificate Issued" near a product (product name) for which the product purchase certificate has been issued. Alternatively, the integrated management server 20 may display the title of a product for which the product purchase certificate has not been issued in bold.

The integrated management server 20 may perform authentication of the user before issuing the product purchase certificate. For example, the integrated management server 20 may display a GUI such as that shown in FIG. 10 on a terminal 70 in a case where biometric authentication of a user who wishes to issue a product purchase certificate has succeeded. In this case, the integrated management server 20 acquires biometric information (for example, a face image) of the user (account holder) in a case where the account of the user is generated. In a case where the user (the user who has logged into the account) wishes to issue a product purchase certificate, the integrated management server 20 acquires biometric information of the user via the terminal 70. For example, the integrated management server 20 instructs the user to take a self-portrait using the terminal 70. The terminal 70 transmits the acquired biometric information to the integrated management server 20. The integrated management server 20 determines that the authentication of the user who wishes to issue a product purchase certificate has succeeded in a case where the biometric information stored in the account and the biometric information acquired from the terminal 70 substantially match. If the authentication of the user who wishes to issue a product purchase certificate has succeeded, the integrated management server 20 displays the GUI shown in FIG. 10 on the terminal 70.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present disclosure has been made apparent by the above description. That is, the present disclosure is suitably applicable, for example, to an information processing system or the like that sells digital content corresponding to a product purchased by a user.

A part or the entirety of the example embodiments described above may be described as in the following supplementary notes, but is not limited to the followings.

### [Supplementary Note 1]

A 3D model utilization apparatus including: an acquisition means that acquires appearance information and genre information related to digital content corresponding to a product purchased by a user; a generation means that generates a 3D model corresponding to the digital content based on the acquired appearance information and genre information; and a utilization means that uses the generated 3D model in a metaverse space.

### [Supplementary Note 2]

The 3D model utilization apparatus according to supplementary note 1, wherein the utilization means arranges the generated 3D model in a predetermined area in accordance with an instruction from the user.

### [Supplementary Note 3]

The 3D model utilization apparatus according to supplementary note 2, wherein the utilization means arranges a plurality of the generated 3D models based on at least one of a market price, a number of transactions, and a number of sales of each of the digital contents.

### [[Supplementary Note 4]

The 3D model utilization apparatus according to supplementary note 1, wherein the utilization means makes the digital content available to a third party other than the user.

### [Supplementary Note5]

The 3D model utilization apparatus according to supplementary note 1, wherein the product purchased by the user is a CD or DVD, and wherein the utilization means reproduces audio data or video data corresponding to the CD or DVD in the metaverse space.

### [Supplementary Note 6]

The 3D model utilization apparatus according to supplementary note 5, wherein the acquisition means acquires playback condition information related to playback conditions of the audio data or video data, and wherein the utilization means reproduces the audio data or video data in accordance with the acquired playback condition information.

### [Supplementary Note 7]

The 3D model utilization apparatus according to supplementary note 5, wherein the acquisition means acquires rental information related to lending and borrowing of the audio data or video data, and wherein the utilization means determines, in accordance with the acquired rental information, whether or not the user can lend the audio data or video data to a third party other than the user.

### [Supplementary Note 8]

The 3D model utilization apparatus according to any one of supplementary notes 1 to 7, wherein the digital content is generated as a non-fungible token (NFT) as a result of the user purchasing the corresponding product in a real world.

### [Supplementary Note 9]

A control method of a 3D model utilization apparatus, the control method including: acquiring appearance information and genre information related to digital content corresponding to a product purchased by a user; generating a 3D model corresponding to the digital content based on the acquired appearance information and genre information; and using the generated 3D model in a metaverse space.

### [Supplementary Note 10]

A program causing a computer mounted on a 3D model utilization apparatus to perform processing for: acquiring appearance information and genre information related to digital content corresponding to a product purchased by a user; generating a 3D model corresponding to the digital content based on the acquired appearance information and genre information; and using the generated 3D model in a metaverse space.

In addition, a part or all of the configurations described in supplementary notes 2 to 8, which are dependent on supplementary note 1 as described above, may also be dependent on supplementary notes 9 and 10 in the same dependent relationship as supplementary notes 2 to 8. Furthermore, not limited to supplementary note 1 and supplementary notes 9 and 10, within a range not departing from the above-described example embodiments, a part or all of the configurations described as supplementary notes can likewise be made dependent on various hardware, software, various recording means for recording the software, or systems.

The entire disclosure of the above patent literature is incorporated herein by reference thereto. While the example embodiments of the present disclosure have thus been described, the present disclosure is not limited to these example embodiments. It is to be understood to those skilled in the art that these example embodiments are only examples and that various variations are possible without departing from the scope and spirit of the present disclosure. That is, the present disclosure of course includes various variations and modifications that could be made by those skilled in the art in accordance with the overall disclosure including the claims and the technical concept.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed disclosure even if the claims are amended during prosecution.

What is claimed is:

1. A 3D model utilization apparatus comprising:
at least one memory storing a set of instructions; and
at least one processor configured to execute the set of instructions to:
acquire appearance information and genre information related to digital content corresponding to a product purchased by a user;
generate a 3D model corresponding to the digital content based on the acquired appearance information and genre information; and
use the generated 3D model in a metaverse space.

2. The 3D model utilization apparatus according to claim 1, wherein
the at least one processor is further configured to execute the set of instructions to arrange the generated 3D model in a predetermined area in accordance with an instruction from the user.

3. The 3D model utilization apparatus according to claim 2, wherein
the at least one processor is further configured to execute the set of instructions to arrange a plurality of the generated 3D models based on at least one of a market price, a number of transactions, and a number of sales of each of the digital contents.

4. The 3D model utilization apparatus according to claim 1, wherein
the at least one processor is further configured to execute the set of instructions to make the digital content available to a third party other than the user.

5. The 3D model utilization apparatus according to claim 1, wherein the product purchased by the user is a CD or DVD, and
wherein the at least one processor is further configured to execute the set of instructions to reproduce audio data or video data corresponding to the CD or DVD in the metaverse space.

6. The 3D model utilization apparatus according to claim 5, wherein
the at least one processor is further configured to execute the set of instructions to:
acquire playback condition information related to playback conditions of the audio data or video data; and
reproduce the audio data or video data in accordance with the acquired playback condition information.

7. The 3D model utilization apparatus according to claim 5, wherein
the at least one processor is further configured to execute the set of instructions to:
acquire rental information related to lending and borrowing of the audio data or video data; and
determine, in accordance with the acquired rental information, whether or not the user can lend the audio data or video data to a third party other than the user.

8. The 3D model utilization apparatus according to claim 1, wherein the digital content is generated as a non-fungible token (NFT) as a result of the user purchasing the corresponding product in a real world.

9. The 3D model utilization apparatus according to claim 2, wherein the digital content is generated as a non-fungible token (NFT) as a result of the user purchasing the corresponding product in a real world.

10. The 3D model utilization apparatus according to claim 3, wherein the digital content is generated as a non-fungible token (NFT) as a result of the user purchasing the corresponding product in a real world.

11. The 3D model utilization apparatus according to claim 4, wherein the digital content is generated as a non-fungible token (NFT) as a result of the user purchasing the corresponding product in a real world.

12. The 3D model utilization apparatus according to claim 5, wherein the digital content is generated as a non-fungible token (NFT) as a result of the user purchasing the corresponding product in a real world.

13. The 3D model utilization apparatus according to claim 6, wherein the digital content is generated as a non-fungible token (NFT) as a result of the user purchasing the corresponding product in a real world.

14. A control method of a 3D model utilization apparatus, the control method comprising:
acquiring appearance information and genre information related to digital content corresponding to a product purchased by a user;
generating a 3D model corresponding to the digital content based on the acquired appearance information and genre information; and
using the generated 3D model in a metaverse space.

15. A non-transitory computer-readable storage medium storing a program causing a computer mounted on a 3D model utilization apparatus to perform processing for:
acquiring appearance information and genre information related to digital content corresponding to a product purchased by a user;
generating a 3D model corresponding to the digital content based on the acquired appearance information and genre information; and
using the generated 3D model in a metaverse space.
